(19) United States
(12) Patent Application Publication
(10) Pub. No.: US 2022/0256631 A1
(43) Pub. Date: Aug. 11, 2022

(54) METHODS AND APPARATUS TO SWITCH BETWEEN WIRELESS NETWORKS

(71) Applicant: QUALCOMM Incorporated, San Diego, CA (US)

(72) Inventors: Sachin JAIN, Santa Clara, CA (US); Bhupesh Manoharlal UMATT, Poway, CA (US); Brian Clarke BANISTER, San Diego, CA (US); Ning LUO, Cupertino, CA (US)

(21) Appl. No.: 17/666,375

(22) Filed: Feb. 7, 2022

Related U.S. Application Data
(60) Provisional application No. 63/147,922, filed on Feb. 10, 2021.

(51) Int. Cl. H04W 76/15; H04B 7/185; H04W 64/00

(52) U.S. Cl. CPC H04W 76/15; H04W 64/00; H04B 7/18513

(57) ABSTRACT

Techniques are provided for selecting cellular and satellite networks. An example method for switching between communication networks includes receiving one or more signals via a first wireless communication network with a mobile device, determining a second wireless communication network is available based at least in part on a location of the mobile device and a time, detaching the mobile device from the first wireless communication network at the time if the second wireless communication network is available, and receiving one or more signals from the second wireless communication network with the mobile device after the time.

### CROSS-REFERENCE TO RELATED APPLICATION

This application claims the benefit of U.S. Provisional Application No. 63/147,922, filed Feb. 10, 2021, entitled “METHODS AND APPARATUS TO SWITCH BETWEEN WIRELESS NETWORKS,” the entire contents of which is hereby incorporated herein by reference for all purposes.

### BACKGROUND

Various aspects described herein relate to wireless terrestrial and satellite based communication networks, and more particularly, to mobile devices configured for multi-network operations. Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax), and a fifth-generation (5G) service (e.g., 5G New Radio (NR)). There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, etc. Satellite based wireless communication systems have also developed and the availability of satellite compatible communication devices is increasing. In general, satellite-based communication systems include gateways and one or more satellites. A satellite may be an orbiting receiver and repeater configured to relay communication signals between the gateways and one or more user terminals. A gateway may be an earth station having an antenna for transmitting signals to and receiving signals from communication satellites. A gateway may be configured to provide communication links for connecting a user terminal to other user terminals or users of other communication systems, such as a public switched telephone network, the Internet, public networks, and private networks. Developments in mobile device technology are enabling multi-network operations such that a single device may be configured to utilize both terrestrial and satellite based communication networks.

### SUMMARY

An example method for switching between communication networks according to the disclosure includes receiving one or more signals via a first wireless communication network with a mobile device, determining a second wireless communication network is available based at least in part on a location of the mobile device and a time, detaching the mobile device from the first wireless communication network at the time if the second wireless communication network is available, and receiving one or more signals from the second wireless communication network with the mobile device after the time.

Implementations of such a method may include one or more of the following features. Determining the second wireless communication network is available may include determining a context for the mobile device. The first wireless communication network may be a cellular network and the second wireless communication network may be a satellite network. The first wireless communication network may be a first satellite network and the second wireless communication network may be a second satellite network. One or more signals may be received from a cellular network concurrently with receiving one or more signals on the first wireless communication network, and one or more signals may be received from the cellular network concurrently with receiving one or more signals on the second wireless communication network. Determining the second wireless communication network is available may include determining that the location of the mobile device at the time is within a coverage area of second wireless communication network. A satellite observation forecast may be received, such that determining the second wireless communication network is available may be based on an indication of one or more detectable satellite vehicles at the location and the time. The satellite observation forecast may be received from a network station. The satellite observation forecast may be received from a proximate user equipment via a sidelink. Satellite observation information may be provided to a network server, such that the satellite observation information is based on signals received from the first wireless communication network, the second wireless communication network, or both.

An example method of communicating on a wireless network according to the disclosure includes determining a context for a user equipment, detecting one or more applications executing on the user equipment, determining one or more wireless communication networks based at least in part on the context and the one or more applications, detecting at least one of the one or more wireless communication networks, and connecting to the at least one of the one or more wireless communication networks based at least in part on priority values associated with the context and the one or more applications.

Implementations of such a method may include one or more of the following features. Determining the context for the user equipment may be based on determining the user equipment is located within a structure. The one or more wireless communication networks may include a cellular network and a satellite communication network. The one or more wireless communication networks may include a first satellite communication network and a second satellite communication network. The one or more wireless communication networks may include a Wi-Fi network and a satellite communication network. The one or more wireless communication networks may include a sidelink based network and a satellite communication network. The one or more applications executing on the user equipment may include at least one of a voice communication application, a messaging application, an email application, a media streaming application, a video calling application, a meeting application, or a navigation application. The method may include connecting to a first wireless network and a second wireless network, such that a first of the one or more applications is configured to utilize the first wireless network and a second of the one or more applications is configured to utilize the second wireless network. The first wireless network may be a cellular network and the second wireless network may be a satellite communication network. The first wireless network may be a sidelink based network and the second wireless network may be a satellite communication network. The first wireless network may be a first satellite communication network and the second wireless network may be a second satellite communication network.

An example method of providing satellite coverage forecasts according to the disclosure includes receiving satellite observation information from a plurality of mobile devices including an observation time and an observation location for each of a plurality of satellite observations performed by the plurality of mobile devices, determining satellite location information based at least in part on the satellite observation information, generating an observation forecast based at least in part on the satellite observation information and the satellite location information, and providing the observation forecast to one or more mobile devices, wherein the observation forecast includes an indication of one or more detectable satellite vehicles based on an estimated position and a time.

Implementations of such a method may include one or more of the following features. The satellite observation information may include observations of signals transmitted by one or more satellite vehicles in a global navigation satellite system. The satellite observation information may include observations of signals transmitted by one or more satellite vehicles in a satellite communication network. Generating the observation forecast may include utilizing one or more machine learning methods with the satellite location information as training data and the satellite observation information as labels. Providing the observation forecast may include transmitting the observation forecast in assistance data via a cellular communication messaging protocol. Providing the observation forecast may include transmitting the observation forecast in assistance data via a sidelink communication messaging protocol.

An example method for switching between communication networks according to the disclosure includes receiving one or more signals via a terrestrial wireless communication network with a mobile device, detecting one or more signals from at least one satellite associated with a global navigation satellite system, determining a satellite communication network is available based at least in part on detecting the one or more signals from the at least one satellite associated with the global navigation satellite system, and detaching the mobile device from the terrestrial wireless communication network and activating a satellite communication mode on the mobile device.

Implementations of such a method may include one or more of the following features. Detecting the one or more signals from the at least one satellite may include detecting a satellite identification code. Determining the satellite communication network is available may include querying a data structure based on the one or more signals from the at least one satellite. The data structure may be stored on a network server and the mobile device may be configured to query the data structure via the terrestrial wireless communication network. A location of the mobile device may be determined and an indication of the one or more signals and the location may be transmitted to a network server.

An example apparatus according to the disclosure includes a memory, at least one transceiver, at least one processor communicatively coupled to the memory and the at least one transceiver, and configured to receive one or more signals via a first wireless communication network, determine a second wireless communication network is available based at least in part on a location and a time, detach from the first wireless communication network at the time if the second wireless communication network is available, and receive one or more signals from the second wireless communication network after the time.

An example apparatus according to the disclosure includes a memory, at least one transceiver, at least one processor communicatively coupled to the memory and the at least one transceiver, and configured to determine a context for a user equipment, detect one or more applications executing on the user equipment, determine one or more wireless communication networks based at least in part on the context and the one or more applications, detect at least one of the one or more wireless communication networks, and connect to the at least one of the one or more wireless communication networks based at least in part on priority values associated with the context and the one or more applications.

An example apparatus according to the disclosure includes a memory, at least one transceiver, at least one processor communicatively coupled to the memory and the at least one transceiver, and configured to receive satellite observation information from a plurality of mobile devices including an observation time and an observation location for each of a plurality of satellite observations performed by the plurality of mobile devices, determine satellite location information based at least in part on the satellite observation information, generate an observation forecast based at least in part on the satellite observation information and the satellite location information, and provide the observation forecast to one or more mobile devices, wherein the observation forecast includes an indication of one or more detectable satellite vehicles based on an estimated position and a time.

An example apparatus according to the disclosure includes a memory, at least one transceiver, at least one processor communicatively coupled to the memory and the at least one transceiver, and configured to receive one or more signals via a terrestrial wireless communication network, detect one or more signals from at least one satellite associated with a global navigation satellite system, determine a satellite communication network is available based at least in part on detecting the one or more signals from the at least one satellite associated with the global navigation satellite system, and detach from the terrestrial wireless communication network and activating a satellite communication mode.

An example apparatus for switching between communication networks according to the disclosure includes means for receiving one or more signals via a first wireless communication network with a mobile device, means for determining a second wireless communication network is available based at least in part on a location of the mobile device and a time, means for detaching the mobile device from the first wireless communication network at the time if the second wireless communication network is available, and means for receiving one or more signals from the second wireless communication network with the mobile device after the time.

An example apparatus for communicating on a wireless network according to the disclosure includes means for determining a context for a user equipment, means for detecting one or more applications executing on the user equipment, means for determining one or more wireless communication networks based at least in part on the context and the one or more applications, means for detecting at least one of the one or more wireless communication networks, and means for connecting to the at least one of the one or more wireless communication networks based at least in part on priority values associated with the context and the one or more applications.

An example apparatus for providing satellite coverage forecasts according to the disclosure includes means for receiving satellite observation information from a plurality of mobile devices including an observation time and an observation location for each of a plurality of satellite observations performed by the plurality of mobile devices, means for determining satellite location information based at least in part on the satellite observation information, means for generating an observation forecast based at least in part on the satellite observation information and the satellite location information, and means for providing the observation forecast to one or more mobile devices, wherein the observation forecast includes an indication of one or more detectable satellite vehicles based on an estimated position and a time.

An example apparatus for switching between communication networks according to the disclosure includes means for receiving one or more signals via a terrestrial wireless communication network with a mobile device, means for detecting one or more signals from at least one satellite associated with a global navigation satellite system, means for determining a satellite communication network is available based at least in part on detecting the one or more signals from the at least one satellite associated with the global navigation satellite system, and means for detaching the mobile device from the terrestrial wireless communication network and activating a satellite communication mode on the mobile device.

An example non-transitory processor-readable storage medium comprising processor-readable instructions configured to cause one or more processors to cause a mobile device to switch between communication networks according to the disclosure includes code for receiving one or more signals via a first wireless communication network with the mobile device, code for determining a second wireless communication network is available based at least in part on a location of the mobile device and a time, code for detaching the mobile device from the first wireless communication network at the time if the second wireless communication network is available, and code for receiving one or more signals from the second wireless communication network with the mobile device after the time.

An example non-transitory processor-readable storage medium comprising processor-readable instructions configured to cause one or more processors to enable communication on a wireless network according to the disclosure includes code for determining a context for a user equipment, code for detecting one or more applications executing on the user equipment, code for determining one or more wireless communication networks based at least in part on the context and the one or more applications, code for detecting at least one of the one or more wireless communication networks, and code for connecting to the at least one of the one or more wireless communication networks based at least in part on priority values associated with the context and the one or more applications.

An example non-transitory processor-readable storage medium comprising processor-readable instructions configured to cause one or more processors to provide satellite coverage forecasts according to the disclosure includes code for receiving satellite observation information from a plurality of mobile devices including an observation time and an observation location for each of a plurality of satellite observations performed by the plurality of mobile devices, code for determining satellite location information based at least in part on the satellite observation information, code for generating an observation forecast based at least in part on the satellite observation information and the satellite location information, and code for providing the observation forecast to one or more mobile devices, wherein the observation forecast includes an indication of one or more detectable satellite vehicles based on an estimated position and a time.

An example non-transitory processor-readable storage medium comprising processor-readable instructions configured to cause one or more processors to enable a mobile device to switch between communication networks according to the disclosure includes code for receiving one or more signals via a terrestrial wireless communication network with the mobile device, code for detecting one or more signals from at least one satellite associated with a global navigation satellite system, code for determining a satellite communication network is available based at least in part on detecting the one or more signals from the at least one satellite associated with the global navigation satellite system, and code for detaching the mobile device from the terrestrial wireless communication network and activating a satellite communication mode on the mobile device.

Items and/or techniques described herein may provide one or more of the following capabilities, as well as other capabilities not mentioned. A mobile device may be operating in a cellular mode and attached to a cellular network. An application or a user may request to set the mobile device to a satellite mode. The mobile device may be configured to determine whether a satellite communication network is detectable. An observation forecast may be utilized to determine if the satellite network is detectable. A context of the mobile device may be used to determine whether a satellite network is detectable. If the satellite network is detectable, the mobile device may detach from the cellular mode and activate a satellite mode. Other capabilities may be provided and not every implementation according to the disclosure must provide any, let alone all, of the capabilities discussed.

### BRIEF DESCRIPTION OF THE DRAWINGS

FIG. 1A is a simplified diagram of an example wireless communications system.

FIG. 1B is a simplified diagram of an example satellite communications system.

FIG. 2 is a block diagram of components of an example user equipment shown in FIGS. 1A and 1B.

FIG. 3 is a block diagram of components of an example transmission/reception point.

FIG. 4 is a block diagram of components of an example server.

FIGS. 5A-5C are example use case diagrams for switching between cellular and satellite communication systems.

FIG. 6A is a diagram of an example change of context for a user equipment.

FIG. 6B is a diagram of an example process for developing satellite coverage observation forecasts.

FIG. 7 is an example data structure for network prioritization.

FIGS. 8A-8E are block flow diagrams of example methods for switching between communication systems.

FIG. 9 is a block flow diagram of an example method for connecting to a wireless communication network.

FIG. 10 is a block flow diagram of an example method for providing assistance data to a user equipment.

FIG. 11 is a block flow diagram of an example method for providing satellite observation forecasts.

FIG. 12 is a block diagram of an example satellite transceiver.

### DETAILED DESCRIPTION

Techniques are discussed herein for selecting cellular and satellite networks. In general, the use of satellite enabled mobile devices, such as smart phones, is increasing for voice, text, and data applications. Motivations for the increases are driven by the potential increase in coverage area and the potential for increases in privacy and personal security. New generation mobile devices, also referred to as user equipment (UE), may be configured to support multiple communication networks and multiple subscription accounts. For example, a UE may be configured for different operation modes such as a cellular only mode, a combined cellular and satellite mode, a satellite only mode, a multi-satellite mode (e.g., configured to operate on two different satellite communication networks), and combinations thereof.

In an embodiment, the cellular and satellite communication modes may be orthogonal and any given time, and the UE may be in a cellular mode or a satellite mode. Switching between a cellular network to a satellite network (and vice-versa) may require the UE to release an ongoing call abruptly (including background data synchronization signals), detach with the cellular network, and switch to a satellite mode and establish a connection with a satellite communication network. The switch between a cellular mode and a satellite mode may impact the sleep/deep sleep operations executing on the UE. The overhead associated with detaching from the cellular and attempting to establish a connection with the satellite network may be wasted if a satellite signal is not available at the time of the switch. For example, this may occur when the UE is out of sight of a satellite, such as when operating indoors, within an urban canyon, or other area with limited access to the open sky. This wasted overhead may needlessly impact power consumption and diminish UE performance and the user experience.

In general, satellite signals are comparatively weaker than terrestrial based cellular signals due to the distance, fading, and environmental conditions. The impact of the signal strength differences is accentuated when the UE is indoors or the satellite signals are obstructed. In an example, the techniques provided herein may select a mode based on whether a sufficient satellite signal is not currently available, or will not be available, at a current or future location. For example, if a satellite signal is not available at a current location a UE will be configured to remain in a cellular mode and avoid switching to a satellite mode. The UE may be configured to utilize satellite navigation signals (e.g., from a Global Navigation Satellite System (GNSS)) to determine whether there will be sufficient satellite communication signals. That is, if a GNSS signal is weak or not available, the UE may be configured to determine it is indoors and that a switch to a satellite communication network is likely to be unsuccessful. The UE may use other techniques such as radar, lidar, mmW antennas, and other sensors and location related services to determine whether the current location is indoors. The UE may be configured to provide a notification to a user to indicate that a switch to a satellite communication network will be unsuccessful. Determining whether a network switch will be successful prior to enacting the switch may help save an ongoing cellular call, and/or avoid wasting the overhead for attach-detach procedures required for entering or existing a cellular mode, and save power used during a potential scan for satellite stations. In an example, the UE may be configured for operations on multiple satellite modes and the techniques described herein may be used for transitions from one satellite communication network to another satellite communication network.

In an embodiment, a UE may be configured to operate in cellular and satellite modes concurrently. The UE may also be configured to concurrently operate other wireless radio access technologies such as WiFi, Bluetooth, and other device-to-device (D2D) sidelinks while in the cellular and/or satellite modes. When multiple communication modes are available, the UE may be configured to select a preferred communication mode based on the current context of the UE. For example, while indoors with a WiFi network, the UE may prefer to utilize the WiFi network rather than a cellular network. Similarly, while in an outdoor area with both cellular and satellite coverage, the UE may be configured to select the cellular network. In an example, different applications executing on the UE may be configured to utilize different wireless technologies based on the current context of the UE. For example, the context of a UE may be that it is in an area with intermittent cellular coverage, and based on this context the UE may utilize a satellite communication network for a voice communication application and a messaging application, and a cellular network for an email application. Other variations of radio access technologies and applications may also be configured based on other contexts. These techniques and configurations are examples, and other techniques and configurations may be used.

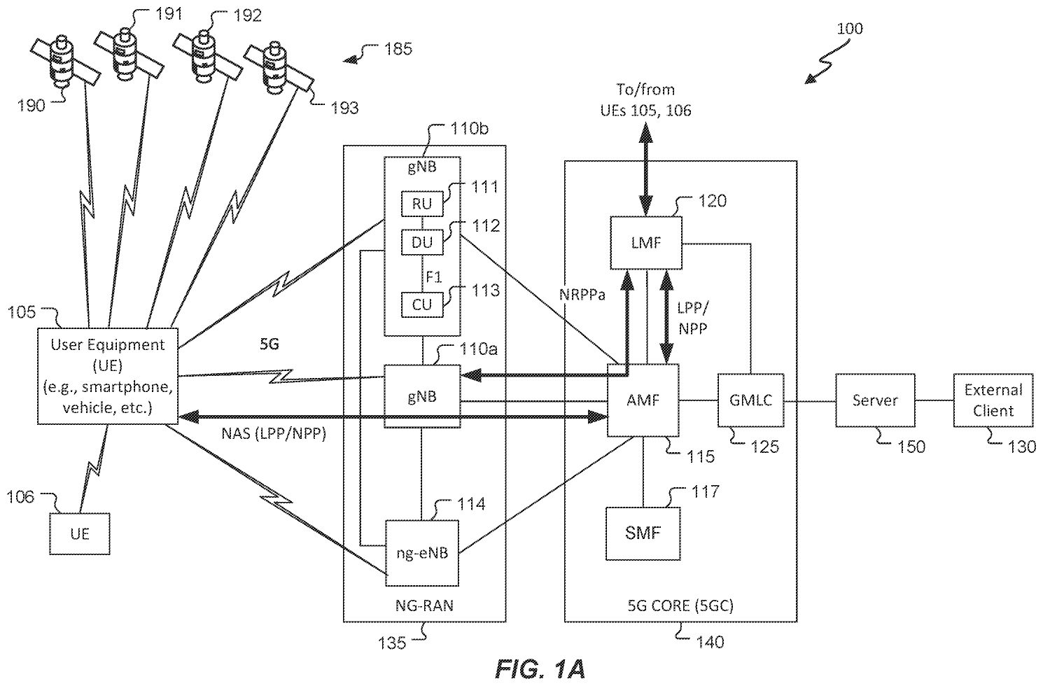

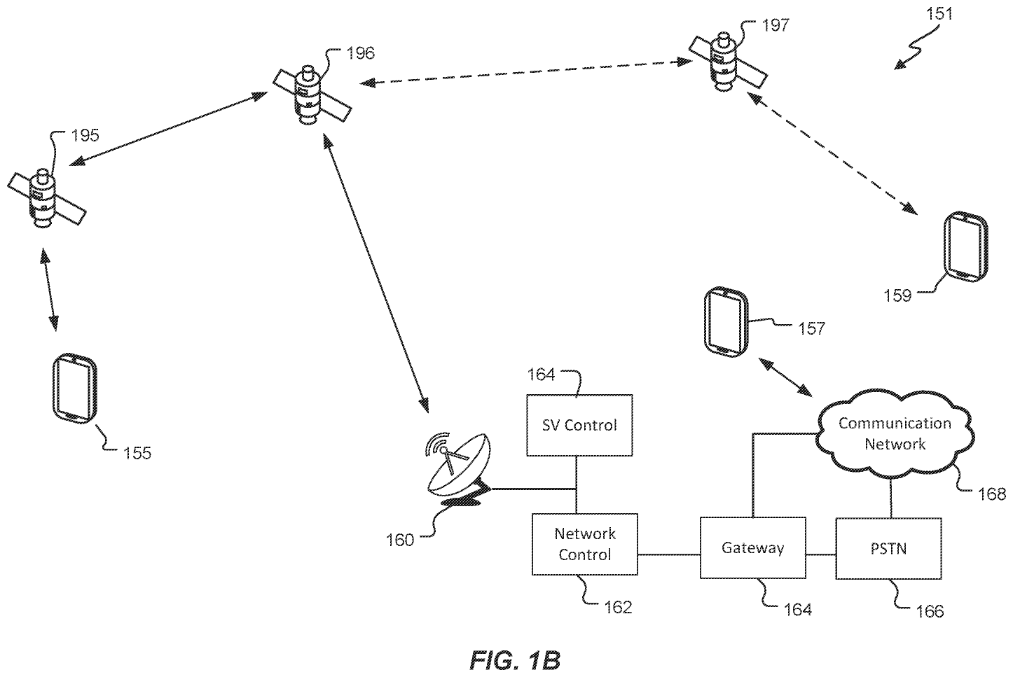

Referring to FIG. 1A, an example of a communication system 100 includes a UE 105, a UE 106, a Radio Access Network (RAN), here a Fifth Generation (5G) Next Generation (NG) RAN (NG-RAN) 135, a 5G Core Network (5GC) 140, and a server 150. The UE 105 and/or the UE 106 may be, e.g., an IoT device, a location tracker device, a cellular telephone, a vehicle (e.g., a car, a truck, a bus, a boat, etc.), or other device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the communication system 100, but such signaling is not indicated in FIG. 1A for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1A, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. Base stations such as the gNBs 110a, 110b and/or the ng-eNB 114 may be a macro cell (e.g., a high-power cellular base station), or a small cell (e.g., a low-power cellular base station), or an access point (e.g., a short-range base station configured to communicate with short-range technology such as WiFi, WiFi-Direct (WiFi-D), Bluetooth®, Bluetooth®-low energy (BLE), Zigbee, etc. One or more BSs, e.g., one or more of the gNBs 110a. 110b and/or the ng-eNB 114 may be configured to communicate with the UE 105 via multiple carriers. Each of the gNBs 110a, 110b and the ng-eNB 114 may provide communication coverage for a respective geographic region, e.g. a cell. Each cell may be partitioned into multiple sectors as a function of the base station antennas.

FIG. 1A provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1A illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a. 110b are examples and may, in various embodiments, be replaced by or include various other location server functionality and/or base station functionality respectively.

The communication system 100 is capable of wireless communication in that components of the communication system 100 can communicate with one another (at least some times using wireless connections) directly or indirectly, e.g., via the gNBs 110a, 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the communication system 100 and may communicate with each other and/or with the UE 105, the gNBs 110a, 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi communication, multiple frequencies of Wi-Fi communication, satellite positioning, one or more types of communications (e.g., GSM (Global System for Mobiles), CDMA (Code Division Multiple Access), LTE (Long-Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi (e.g., DSRC (Dedicated Short-Range Connection)). The communication system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH).

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE. High Rate Packet Data (HRPD), IEEE 802.11 WiFi (also referred to as Wi-Fi), Bluetooth® (BT), Worldwide Interoperability for Microwave Access (WiMAX), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1A, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi Direct (WiFi-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1A include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1A, the serving gNB for the UE 105 is assumed to be the gNB 110a, although another gNB (e.g. the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1A may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may comprise a TRP, although multiple TRPs may share one or more components (e.g., share a processor but have separate antennas). The communication system 100 may include macro TRPs exclusively or the communication system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Each of the gNBs 110a, 110b and/or the ng-eNB 114 may include a radio unit (RU), a distributed unit (DU), and a central unit (CU). For example, the gNB 110a includes an RU 111, a DU 112, and a CU 113. The RU 111, DU 112, and CU 113 divide functionality of the gNB 110a. While the gNB 110a is shown with a single RU, a single DU, and a single CU, a gNB may include one or more RUs, one or more DUs, and/or one or more CUs. An interface between the CU 113 and the DU 112 is referred to as an F1 interface. The RU 111 is configured to perform digital front end (DFE) functions (e.g., analog-to-digital conversion, filtering, power amplification, transmission/reception) and digital beamforming, and includes a portion of the physical (PHY) layer. The RU 111 may perform the DFE using massive multiple input/multiple output (MIMO) and may be integrated with one or more antennas of the gNB 110a. The DU 112 hosts the Radio Link Control (RLC), Medium Access Control (MAC), and physical layers of the gNB 110a. One DU can support one or more cells, and each cell is supported by a single DU. The operation of the DU 112 is controlled by the CU 113. The CU 113 is configured to perform functions for transferring user data, mobility control, radio access network sharing, positioning, session management. etc. although some functions are allocated exclusively to the DU 112. The CU 113 hosts the Radio Resource Control (RRC). Service Data Adaptation Protocol (SDAP), and Packet Data Convergence Protocol (PDCP) protocols of the gNB 110a. The UE 105 may communicate with the CU 113 via RRC, SDAP, and PDCP layers, with the DU 112 via the RLC, MAC, and PHY layers, and with the RU 111 via the PHY layer.

As noted, while FIG. 1A depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1A.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g. by the LMF 120). The AMF 115 may serve as a control node that processes signaling between the UE 105 and the 5GC 140, and may provide QoS (Quality of Service) flow and session management. The AMF 115 may support mobility of the UE 105 including cell change and handover and may participate in supporting signaling connection to the UE 105.

The server 150, e.g., a cloud server, is configured to obtain and provide location estimates of the UE 105 to the external client 130. The server 150 may, for example, be configured to run a microservice/service that obtains the location estimate of the UE 105. The server 150 may, for example, pull the location estimate from (e.g., by sending a location request to) the UE 105, one or more of the gNBs 110a, 110b (e.g., via the RU 111, the DU 112, and the CU 113) and/or the ng-eNB 114, and/or the LMF 120. As another example, the UE 105, one or more of the gNBs 110a, 110b (e.g., via the RU 111, the DU 112, and the CU 113), and/or the LMF 120 may push the location estimate of the UE 105 to the server 150.

The GMLC 125 may support a location request for the UE 105 received from the external client 130 via the server 150 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130 via the server 150. The GMLC 125 is shown connected to both the AMF 115 and LMF 120, though may not be connected to the AMF 115 or the LMF 120 in some implementations.

As further illustrated in FIG. 1A, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1A, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS or PRS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS or PRS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such embodiments, the 5GC 140 may be configured to control different air interfaces. For example, the 5GC 140 may be connected to a WLAN using a Non-3GPP InterWorking Function (N3IWF, not shown FIG. 1A) in the 5GC 140. For example, the WLAN may support IEEE 802.11 WiFi access for the UE 105 and may comprise one or more WiFi APs. Here, the N3IWF may connect to the WLAN and to other elements in the 5GC 140 such as the AMF 115. In some embodiments, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other embodiments, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi APs, an MME, and an E-SMLC.

As noted, in some embodiments, positioning functionality may be implemented, at least in part, using the directional SS or PRS beams, sent by base stations (such as the gNBs 110a, 110b, and/or the ng-eNB 114) that are within range of the UE whose position is to be determined (e.g., the UE 105 of FIG. 1A). The UE may, in some instances, use the directional SS or PRS beams from a plurality of base stations (such as the gNBs 110a, 110b, the ng-eNB 114, etc.) to compute the UE's position.

Referring to FIG. 1B, an example satellite communication system 151 includes a first UE 155, a plurality of satellite vehicles (SVs) 195, 196, 197, and an earth station (ES) or base station (BS) 160. The UE 155 may be a mobile device or user terminal configured for use with a satellite communication system. The UE 155 may be, for example, a satellite phone, a multi-mode cellular-sat phone, an asset tracker, an IoT device, or other devices. The satellite communication system 151 is an example of a generic satellite communication system, and proprietary systems such as Inmarsat, Iridium, Thuraya, and Globalstar are examples of the satellite communication system 151. A first SV 195 is communicating with the first UE 155 via a line of sight (LOS) beam, and the first SV 195 may communicate with other SVs, such as a second SV 196, which may communicate with the BS 160 and/or another SV, such as a third SV 197. In general, the BS 160 includes a control module 164 configured to control the SVs 195, 196, 197 and a network control module 162 configured to control the routing of data through the satellite communication system 151. The BS 160 may perform functions similar to functions of a base station in a cellular network. For example, the BS 160 may be configured to keep track of all the UEs in a coverage area and may control the allocation of radio resources. The SVs 195, 196, 197 may be configured to perform as relay stations. A gateway module 164 may be configured to control data into and out of the satellite communication system 151, such as data sent and received via a public switching telephone network (PSTN) 166, or other communication networks 168. The communication system 100 in FIG. 1A is an example of the communication network 168. The communication network 168 may include other satellite communication networks. In operation, the BS 160 may be configured to route a communication between the first UE 155 and a second UE 157 via the first and second SVs 195, 196 and the communication network 168 (e.g., when the second UE 157 is not capable of satellite communications). In an example, the BS 160 may be configured to route a communication between the first UE 155 and a third UE 159 via the SVs 195, 196, 197 (e.g., when the third UE 159 is satellite capable).

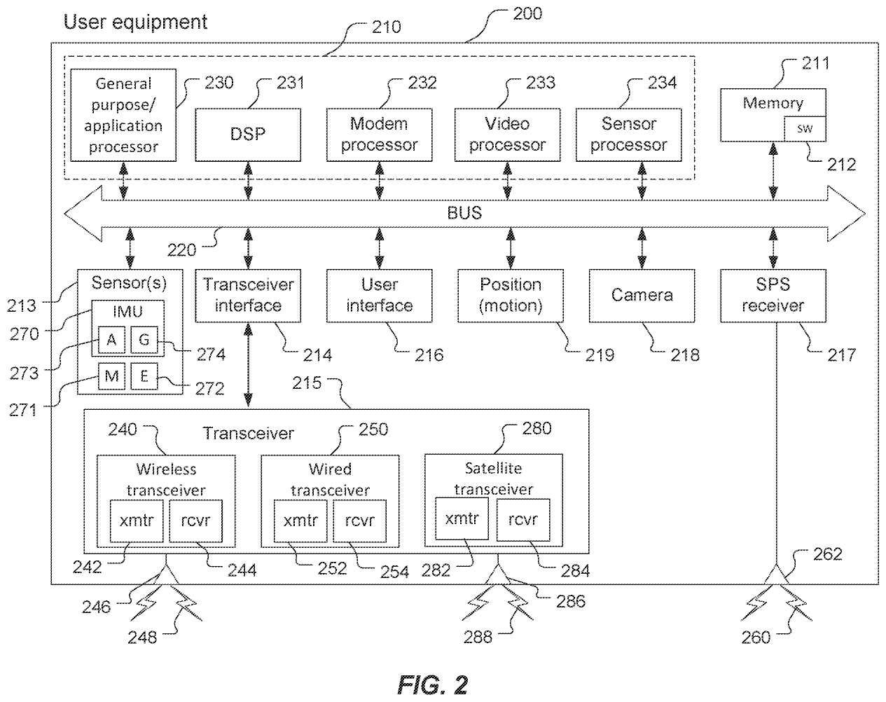

Referring also to FIG. 2, a UE 200 is an example of the UE 105 and comprises a computing platform including a processor 210, memory 211 including software (SW) 212, one or more sensors 213, a transceiver interface 214 for a transceiver 215, a user interface 216, a Satellite Positioning System (SPS) receiver 217, a camera 218, and a position (motion) device 219. The processor 210, the memory 211, the sensor(s) 213, the transceiver interface 214, the user interface 216, the SPS receiver 217, the camera 218, and the position (motion) device 219 may be communicatively coupled to each other by a bus 220 (which may be configured. e.g., for optical and/or electrical communication). One or more of the shown apparatus (e.g., the camera 218, the position (motion) device 219, and/or one or more of the sensor(s) 213, etc.) may be omitted from the UE 200. The processor 210 may include one or more intelligent hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for radar, ultrasound, and/or lidar, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 is a non-transitory storage medium that may include random access memory (RAM), flash memory, disc memory, and/or read-only memory (ROM), etc. The memory 211 stores the software 212 which may be processor-readable, processor-executable software code containing instructions that are configured to, when executed, cause the processor 210 to perform various functions described herein. Alternatively, the software 212 may not be directly executable by the processor 210 but may be configured to cause the processor 210. e.g., when compiled and executed, to perform the functions. The description may refer to the processor 210 performing a function, but this includes other implementations such as where the processor 210 executes software and/or firmware. The description may refer to the processor 210 performing a function as shorthand for one or more of the processors 230-234 performing the function. The description may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE includes one or more of the processors 230-234 of the processor 210, the memory 211, the wireless transceiver 240, and the satellite transceiver 280. Other example configurations include one or more of the processors 230-234 of the processor 210, the memory 211, the wireless transceiver 240, the satellite transceiver 280, and one or more of the sensor(s) 213, the user interface 216, the SPS receiver 217, the camera 218, the PMD 219, and/or the wired transceiver 250.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the processor 230 and/or the DSP 231. Other configurations, however, may be used to perform baseband processing.

The UE 200 may include the sensor(s) 213 that may include, for example, an Inertial Measurement Unit (IMU) 270, one or more magnetometers 271, and/or one or more environment sensors 272. The IMU 270 may comprise one or more inertial sensors, for example, one or more accelerometers 273 (e.g., collectively responding to acceleration of the UE 200 in three dimensions) and/or one or more gyroscopes 274. The magnetometer(s) may provide measurements to determine orientation (e.g., relative to magnetic north and/or true north) that may be used for any of a variety of purposes, e.g., to support one or more compass applications. The environment sensor(s) 272 may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and report the relative displacement/distance (e.g., via dead reckoning, or sensor-based location determination, or sensor-assisted location determination enabled by the sensor(s) 213). In another example, for relative positioning information, the sensors/IMU can be used to determine the angle and/or orientation of the other device with respect to the UE 200, etc.

The IMU 270 may be configured to provide measurements about a direction of motion and/or a speed of motion of the UE 200, which may be used in relative location determination. For example, the one or more accelerometers 273 and/or the one or more gyroscopes 274 of the IMU 270 may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) 273 and gyroscope(s) 274 taken after this moment in time may be used in dead reckoning to determine present location of the UE 200 based on movement (direction and distance) of the UE 200 relative to the reference location.

The magnetometer(s) 271 may determine magnetic field strengths in different directions which may be used to determine orientation of the UE 200. For example, the orientation may be used to provide a digital compass for the UE 200. The magnetometer(s) 271 may include a two-dimensional magnetometer configured to detect and provide indications of magnetic field strength in two orthogonal dimensions. Also or alternatively, the magnetometer(s) 271 may include a three-dimensional magnetometer configured to detect and provide indications of magnetic field strength in three orthogonal dimensions. The magnetometer(s) 271 may provide means for sensing a magnetic field and providing indications of the magnetic field, e.g., to the processor 210.

The transceiver 215 may include one or more of a wireless transceiver 240, a wired transceiver 250, a satellite transceiver 280 configured to communicate with other devices through wireless connections or wired connections. For example, the wireless transceiver 240 may include a transmitter 242 and receiver 244 coupled to one or more antennas 246 for transmitting (e.g., on one or more uplink channels) and/or receiving (e.g., on one or more downlink channels) wireless signals 248 and transducing signals from the wireless signals 248 to wired (e.g., electrical and/or optical) signals and from wired (e.g., electrical and/or optical) signals to the wireless signals 248. Thus, the transmitter 242 may include multiple transmitters that may be discrete components or combined/integrated components, and/or the receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (Vehicle-to-Everything) (PC5), IEEE 802.11 (including IEEE 802.11p), WiFi, WiFi Direct (WiFi-D), Bluetooth®, Zigbee etc. New Radio may use mm-wave frequencies and/or sub-6 GHz frequencies. The wired transceiver 250 may include a transmitter 252 and a receiver 254 configured for wired communication, e.g., with the NG-RAN 135 to send communications to, and receive communications from, the gNB 110a, for example. The transmitter 252 may include multiple transmitters that may be discrete components or combined/integrated components, and/or the receiver 254 may include multiple receivers that may be discrete components or combined/integrated components. The wired transceiver 250 may be configured, e.g., for optical communication and/or electrical communication. In an example, the UE 200 may include the satellite transceiver 280 configured with a transmitter 282 and a receiver 284 coupled to one or more antennas 286 for transmitting (e.g., on one or more uplink channels) and/or receiving (e.g., on one or more downlink channels) wireless signals 288 and transducing signals from the wireless signals 288 to wired (e.g., electrical and/or optical) signals and from wired (e.g., electrical and/or optical) signals to the wireless signals 288. Thus, the transmitter 282 may include multiple transmitters that may be discrete components or combined/integrated components, and/or the receiver 284 may include multiple receivers that may be discrete components or combined/integrated components. The satellite transceiver 280 may be configured to communicate signals (e.g., with satellite vehicles and/or other devices) according to various public and proprietary satellite communication technologies such as Inmarsat, Iridium, Thuraya and Globalstar. The transceiver 215 may be communicatively coupled to the transceiver interface 214, e.g., by optical and/or electrical connection. The transceiver interface 214 may be at least partially integrated with the transceiver 215.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The antenna 262 is configured to transduce the wireless signals 260 to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240 and or the satellite transceiver 280) for use in performing positioning operations. The general-purpose processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS imager), a lens, analog-to-digital circuitry, frame buffers, etc. Additional processing, conditioning, encoding, and/or compression of signals representing captured images may be performed by the general-purpose processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position (motion) device (PMD) 219 may be configured to determine a position and possibly motion of the UE 200. For example, the PMD 219 may communicate with, and/or include some or all of, the SPS receiver 217. The PMD 219 may also or alternatively be configured to determine location of the UE 200 using terrestrial-based signals (e.g., at least some of the signals 248) for trilateration, for assistance with obtaining and using the SPS signals 260, or both. The PMD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PMD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the processor 230 and/or the DSP 231) may be configured to use to determine motion (e.g., a velocity vector and/or an acceleration vector) of the UE 200. The PMD 219 may be configured to provide indications of uncertainty and/or error in the determined position and/or motion.

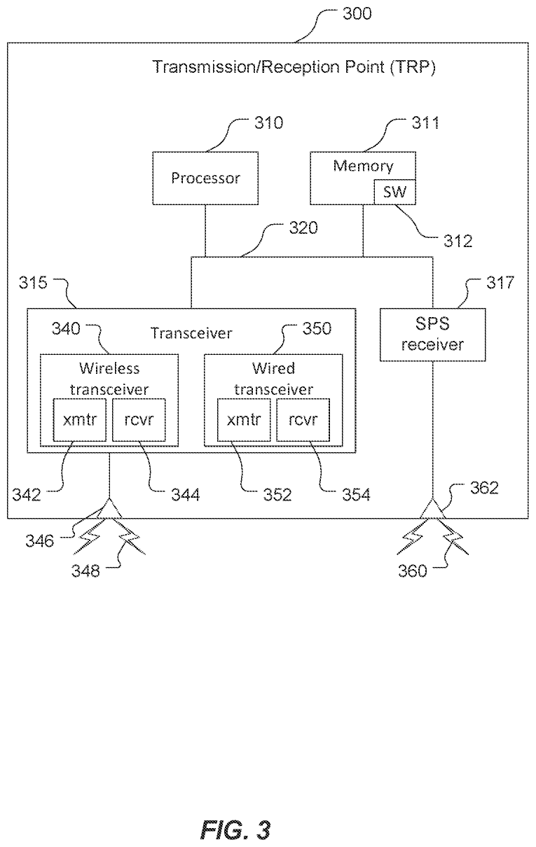

Referring also to FIG. 3, an example of a TRP 300 of the BSs (e.g., gNB 110a, gNB 110b, ng-eNB 114) comprises a computing platform including a processor 310, memory 311 including software (SW) 312, a transceiver 315, and (optionally) an SPS receiver 317. The processor 310, the memory 311, the transceiver 315, and the SPS receiver 317 may be communicatively coupled to each other by a bus 320 (which may be configured, e.g., for optical and/or electrical communication). One or more of the shown apparatus (e.g., a wireless interface and/or the SPS receiver 317) may be omitted from the TRP 300. The SPS receiver 317 may be configured similarly to the SPS receiver 217 to be capable of receiving and acquiring SPS signals 360 via an SPS antenna 362. The processor 310 may include one or more intelligent hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 is a non-transitory storage medium that may include random access memory (RAM)), flash memory, disc memory, and/or read-only memory (ROM), etc. The memory 311 stores the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions. The description may refer to the processor 310 performing a function, but this includes other implementations such as where the processor 310 executes software and/or firmware. The description may refer to the processor 310 performing a function as shorthand for one or more of the processors contained in the processor 310 performing the function. The description may refer to the TRP 300 performing a function as shorthand for one or more appropriate components of the TRP 300 (and thus of one of the gNB 110a, gNB 110b, ng-eNB 114) performing the function. The processor 310 may include a memory with stored instructions in addition to and/or instead of the memory 311. Functionality of the processor 310 is discussed more fully below.

The transceiver 315 may include a wireless transceiver 340 and a wired transceiver 350 configured to communicate with other devices through wireless connections and wired connections, respectively. For example, the wireless transceiver 340 may include a transmitter 342 and receiver 344 coupled to one or more antennas 346 for transmitting wireless signals 348 and transducing signals from the wireless signals 348 to wired (e.g., electrical and/or optical) signals and from wired (e.g., electrical and/or optical) signals to the wireless signals 348. The wireless transceiver 340 may be configured for satellite communications. Thus, the transmitter 342 may include multiple transmitters that may be discrete components or combined/integrated components, and/or the receiver 344 may include multiple receivers that may be discrete components or combined/integrated components. The wireless transceiver 340 may be configured to communicate signals (e.g., with the UE 200, one or more other UEs, and/or one or more other devices) according to a variety of satellite and terrestrial radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®. Zigbee, Inmarsat, Iridium, Thuraya. Globalstar, etc. The wired transceiver 350 may include a transmitter 352 and a receiver 354 configured for wired communication, e.g., with the 5GC 140 to send communications to, and receive communications from, the LMF 120, for example. The transmitter 352 may include multiple transmitters that may be discrete components or combined/integrated components, and/or the receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 is configured to perform or performs several functions, but one or more of these functions may be performed by the LMF 120 and/or the UE 200 (i.e., the LMF 120 and/or the UE 200 may be configured to perform one or more of these functions).

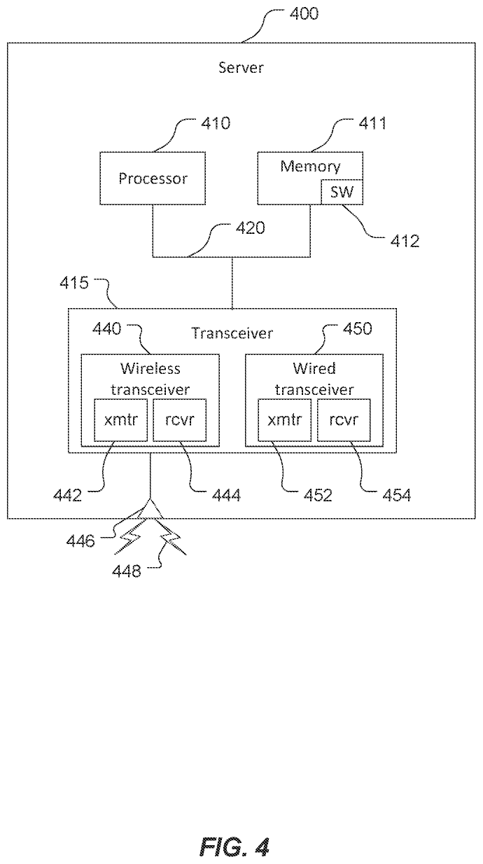

Referring also to FIG. 4, an example of the LMF 120 comprises a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless interface) may be omitted from the server 400. The processor 410 may include one or more intelligent hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 is a non-transitory storage medium that may include random access memory (RAM)), flash memory, disc memory, and/or read-only memory (ROM), etc. The memory 411 stores the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description may refer to the processor 410 performing a function, but this includes other implementations such as where the processor 410 executes software and/or firmware. The description may refer to the processor 410 performing a function as shorthand for one or more of the processors contained in the processor 410 performing the function. The description may refer to the server 400 (or the LMF 120) performing a function as shorthand for one or more appropriate components of the server 400 (e.g., the LMF 120) performing the function. The processor 410 may include a memory with stored instructions in addition to and/or instead of the memory 411. Functionality of the processor 410 is discussed more fully below.

The transceiver 415 may include a wireless transceiver 440 and a wired transceiver 450 configured to communicate with other devices through wireless connections and wired connections, respectively. For example, the wireless transceiver 440 may include a transmitter 442 and receiver 444 coupled to one or more antennas 446 for transmitting (e.g., on one or more uplink channels) and/or receiving (e.g., on one or more downlink channels) wireless signals 448 and transducing signals from the wireless signals 448 to wired (e.g., electrical and/or optical) signals and from wired (e.g., electrical and/or optical) signals to the wireless signals 448. The wireless transceiver 440 may be configured for satellite communications. Thus, the transmitter 442 may include multiple transmitters that may be discrete components or combined/integrated components, and/or the receiver 444 may include multiple receivers that may be discrete components or combined/integrated components. The wireless transceiver 440 may be configured to communicate signals (e.g., with the UE 200, one or more other UEs, and/or one or more other devices) according to a variety of satellite and terrestrial radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution). LTE Direct (LTE-D), 3GPP LTE-V2X (PC5), IEEE 802.11 (including IEEE 802.11p), WiFi, WiFi Direct (WiFi-D), Bluetooth®, Zigbee, Inmarsat, Iridium, Thuraya, Globalstar, etc. The wired transceiver 450 may include a transmitter 452 and a receiver 454 configured for wired communication, e.g., with the NG-RAN 135 to send communications to, and receive communications from, the TRP 300, for example. The transmitter 452 may include multiple transmitters that may be discrete components or combined/integrated components, and/or the receiver 454 may include multiple receivers that may be discrete components or combined/integrated components. The wired transceiver 450 may be configured, e.g., for optical communication and/or electrical communication.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

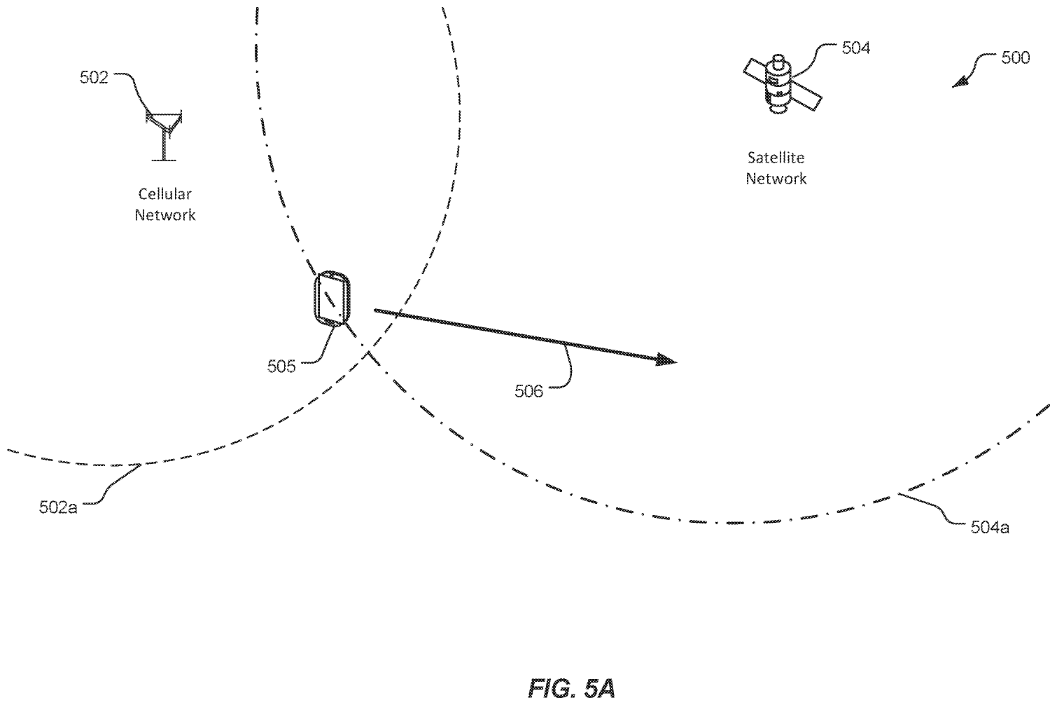

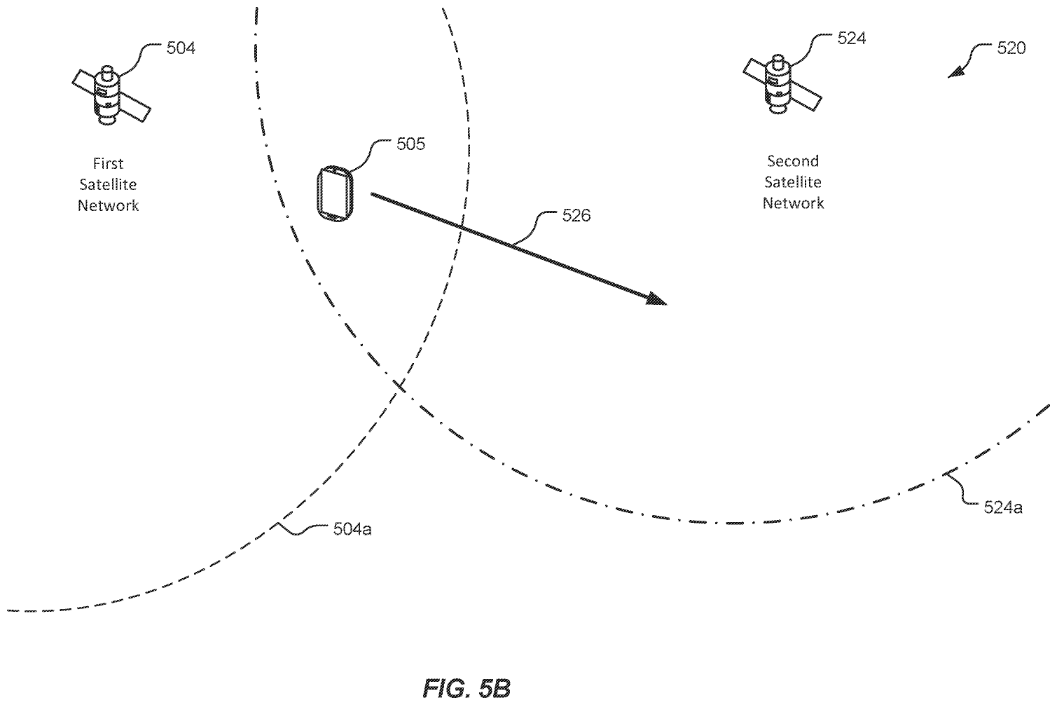

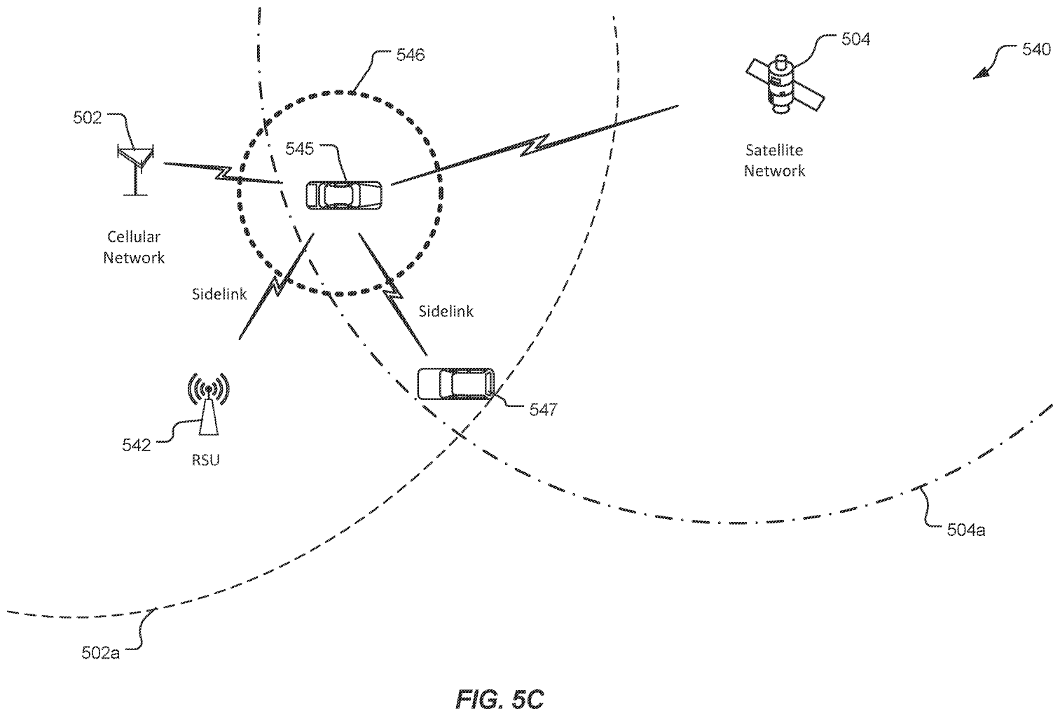

Referring to FIGS. 5A-5C, example use case diagrams for switching between cellular and satellite communication systems are shown. FIG. 5A depicts a first example use case 500 including a base station 502, a SV 504 and a UE 505. The gNB 110a in the communication system 100 is an example of the base station 502 and the SV 195 in the satellite communication system 151 is an example of the SV 504. The UE 505 may include some or all of the components of the UE 200, and the UE 200 may be an example of the UE 505. The base station 502 may have a coverage area 502a and the SV 504 may have a coverage area 504a. The UE 505 is currently in a location which is within both of the coverage areas 502a, 504a and is moving along a trajectory 506 and will lose the signal from the base station 502 (i.e., the UE 505 will exit the coverage area 502a). The UE 505 may be communicating with the base station 502 and utilizing the corresponding cellular network. In an example, the UE 505 may be configured to determine a location context based on satellite and/or terrestrial navigation methods and may be configured to utilize the location context as a trigger for switching from the cellular network via the base station 502 to a satellite communication network via the SV 504. The location of the UE 505 relative to the respective coverage areas may be a trigger for requesting a switch to a satellite mode. In an example, the UE 505 may be configured to verify the strength of GNSS signals (e.g., via the SPS receiver 217) and determine that satellite signals are detectable (e.g., the UE 505 is not in an indoor location). The UE 505 may be configured to detect a satellite prior to detaching from the cellular network. If the SV 504 is detected, the UE 505 may detach from the cellular network (e.g., the base station 502) and activate the satellite mode to connect to the SV 504. If the SV 504 is not detected, the UE 505 may remain in cellular mode and attempt to connect to another cellular network, or may attempt to connect to another satellite communication network.

Referring to FIG. 5B, a second example use case 520 includes the SV 504, which is configured to operate in a first satellite network, and a second SV 524 which is configure to operate in a second satellite network. The SVs 504, 524 have respective coverage areas 504a, 524a. In an example, the UE 505 may be in a first satellite mode and may be participating in the first satellite network via the SV 504. The UE 505 may be on a trajectory 526 and will be exiting the coverage area 504a and/or the SV 504 is moving relative to the UE 505 which will cause the UE 505 to exit the coverage area 504a. The pending loss of coverage may be a trigger for the UE 505 to request a connection to the second satellite network via the second SV 524. The UE 505 may be configured to detect a signal for the second SV 524 and release the connection to the first satellite network if the second SV 524 (or another satellite in the second satellite network is detected). The UE 505 may then switch to the second satellite mode and join the second satellite network.

Referring to FIG. 5C, a third example use case 540 includes a first vehicle 545, which may include some or all of the components of the UE 200 and is configured to utilize multiple radio access technologies simultaneously. For example, the first vehicle 545 may be utilizing vehicle-to-everything (V2X) technology and may be configured to communicate with the base station 502, the SV 504, a roadside unit (RSU) 542, and a second vehicle 547. The first vehicle 545 may, for example, utilize the V2X Uu interface to communicate with the base station 502 and the PC5 sidelink protocol to communicate with the RSU 542 and the second vehicle 547. In an example, the second vehicle 547 may be a node in a mesh network, and the first vehicle may be configured to join the mesh network via a sidelink to the second vehicle 547. The vehicle 545 may also communicate with a satellite communication network via the SV 504 and the associated protocols (e.g., based in proprietary architectures associated with Inmarsat, Iridium, Thuraya, Globalstar, etc.). The first vehicle 545 may be associated with a context 546 which conceptually describes the general operational environment around the first vehicle 545 as well as the current state of the vehicle 545. For example, the context 546 may be travelling on an open road, travelling on an urban road, travelling on a congested road, or stopped in traffic. Other factors such as time, date, geographic location and distances to other stations may be used to define a context for the first vehicle 545. Equipment state related parameters such as power level, the status of receive and transmit processor stacks, sleep mode, the detection of radio signals, and user preferences may be used to define the context. These are examples, and not limitations, as other system and environmental parameters may be used to define the current context of a UE or vehicle.

In operation, the vehicle 545 may be configured to utilize one or more of the multiple radio access technologies based on the current context 546. In an example, the vehicle 545 may prioritize which radio access technology to utilize relative to one another. For example, if the context indicates the vehicle 545 is in slow moving traffic, then the RSU 542 may be prioritized when the signal is available since it may provide increased bandwidth at a limited range. In an urban context, where there are an increased number of available base stations, the vehicle may prioritize the cellular network over the satellite network based on costs associated with the networks (i.e., data charges on a cellular network may be less than on a satellite network). In a rural context, where cellular coverage is sparse, the vehicle 545 may prioritize the satellite network to ensure sustained communications. Other context based priorities may also be assigned. In an embodiment, the vehicle 545 may be configured to bifurcate the use of two or more radio access technologies based on the applications consuming the network resources. For example, in a given context, the cellular network may be prioritized for voice communications, the satellite network may be prioritized for messaging applications, and the RSU (V2X network) may be prioritized for streaming applications.

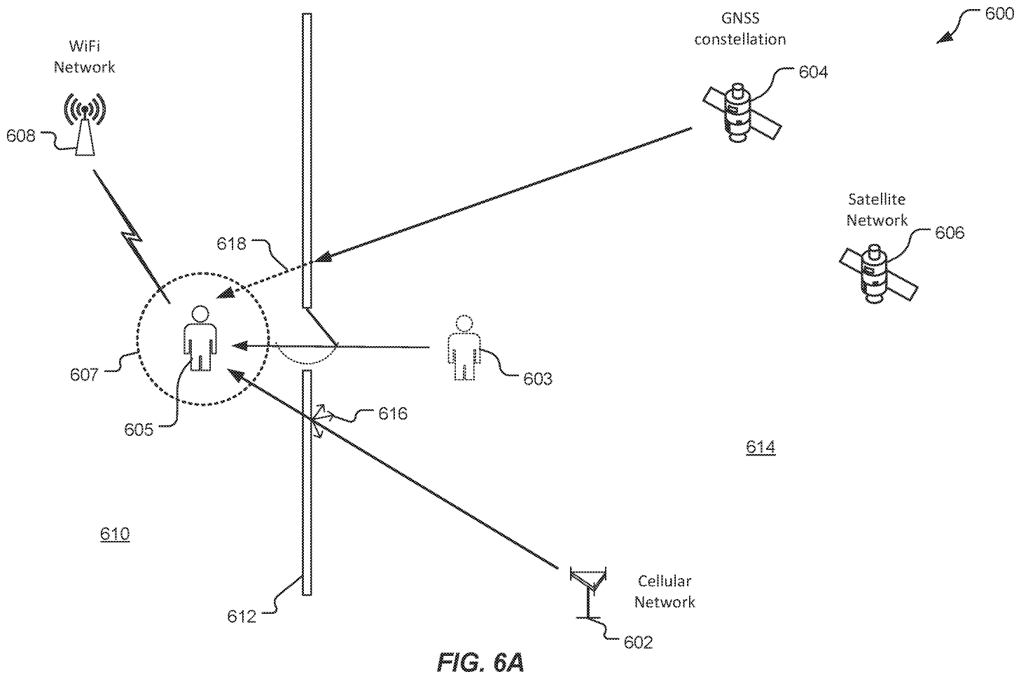

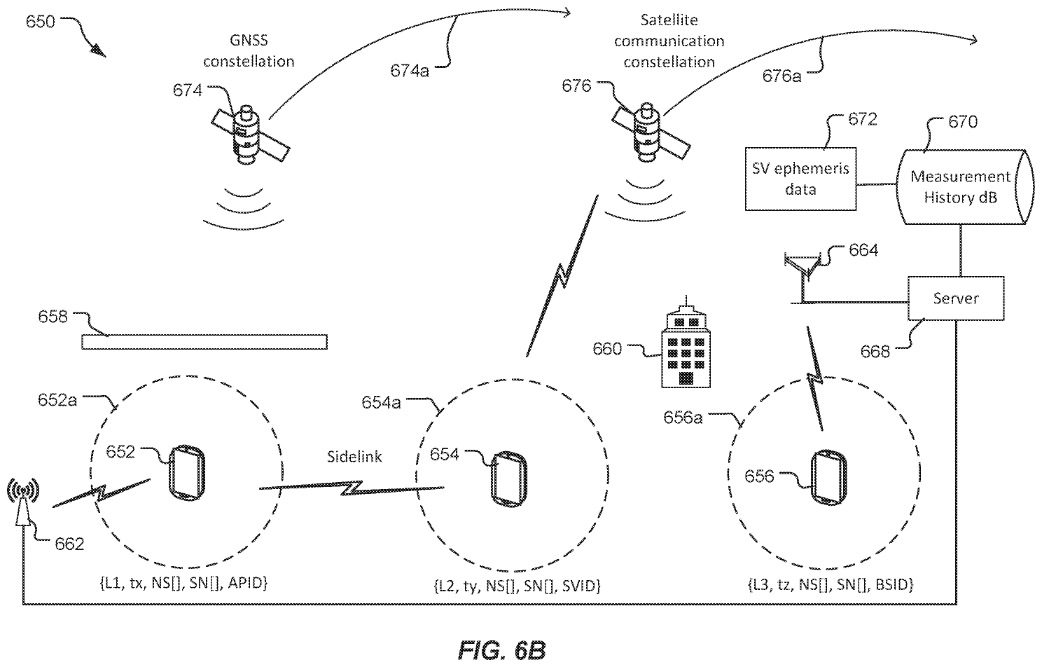

Referring to FIG. 6A, a diagram 600 of an example change in context for a user equipment is shown. The diagram 600 includes a user 605, who is carrying or wearing a UE, a base station 602, a GNSS constellation 604, a satellite communications SV 606, and a WiFi access point 608. The different radio access technologies in FIG. 6A are examples, and not limitations, as other radio access technologies as previously described may be used. The diagram 600 includes a barrier 612 such as a wall, roof, or other structures to define an inside area 610 relative to an outside area 614. The user 605 may be in an outside location 603 and may be utilizing a cellular network via the base station 602. The UE may also utilize signals from one or more SVs in the GNSS constellation 604 while in the outside location 603. As the user 605 moves from the outside location 603 to the inside area 610, the signal strength of the signals transmitted by the base station 602 may decrease because the signals transmitted by the base station 602 may be attenuated, refracted and/or reflected by the barrier 612. The attenuation 616 in the diagram 600 is a graphic representation of the potential signal loss. In response to the loss or reduction of the cellular signal, the UE may be configured to attempt to switch to another radio access technology, such as using a satellite communication technology. Prior to disconnecting with the cellular network, the UE may attempt to determine whether the current context 607 is an indoors location. For example, the UE may utilize sensors such as RF sensing, radar, lidar, coherent light and/or camera based methods to detect barriers or other indications of an indoor location. In an embodiment, a satellite communication system may RF fingerprinting data (e.g., heat maps) to define service sub-areas within a general coverage area, where service may not be available is some sub-areas (e.g., due to obstructions). The RF fingerprint data may be time based as the configuration for some satellite constellations relative to the Earth's surface may continually change (e.g., for low earth orbit constellations). In an embodiment, the UE may obtain an observation forecast associated with the current location and time to determine if a satellite network will be available. The UE may be configured to detect the WiFi access point 608 and/or utilize other positioning methods to determine the context. In an example, the UE may utilize the signals transmitted from the GNSS constellation 604 to determine if signals from a SV 606 in a satellite communication network will be received. For example, a GNSS signal 618 may also be diminished or undetected by the UE when the user 605 is located in the indoor area 610. The UE may be configured to maintain the cellular connection, or attempt to join another network, based on the lack of a GNSS signal.

Referring to 6B, a diagram 650 of an example process for developing satellite coverage observation forecasts is shown. The diagram 650 includes a GNSS satellite constellation 674 with satellites moving in their respective orbits 674a, and a satellite communication constellation 676, with satellites moving in their respective orbits 676a. Example UEs, including a first UE 652 in a first location 652a, a second UE 654 in a second location 654a, and a third UE 656 in a third location 656a are configured to utilize the GNSS satellite constellation 674 and the satellite communication constellation 676. The locations 652a, 654a, 656a are within the general coverage areas of the satellite constellations 674, 676, however, local obstructions such as a barrier 658 and a building 660 may obstruct the line of sight between a UE and a satellite. The barrier 658 and building 660 are examples as other geological and man-made structures may obstruct signals between a UE and a satellite. The UEs 652, 654, 656 may be configure to communicate with one or more wireless networks and the corresponding network stations. For example, the first UE 652 may be communicating with a WiFi access point 662, the second UE 654 may be communicating with a SV in the communication constellation 676, and the third UE 656 may be communicating with a cellular base station 664. In an example, the first UE 654 and the second UE 654 may be configured to communicate via a sidelink connection (e.g., PC5). The access point 662, the SV, and the base station 664 may be communicatively coupled to one or more network servers 668, such as the LMF 120, via a WWAN and/or the Internet. The server 668 may include some or all of the components of the server 400, and the server 400 is an example of the server 668. The network server 668 may be configured to interact with a measurement history database 670 and SV ephemeris data 672. The measurement history database 670 may be a relational database (e.g., SQL, Oracle, etc.), or other flat file configurations (e.g., XML, JSON, CSV, etc.) configured to store satellite observation information received from UEs in a network. The SV ephemeris data 672 may include celestial coordinate and associated SV information for the GNSS and satellite communication constellations 674, 676.

In an embodiment, the UEs 652, 654, 656 are configured to obtain satellite observation information at their respective locations 652a, 654a, 656a (e.g., L1, L2, L3) and a respective time of the observations (e.g., tx, ty, tz). The observations may be obtained periodically (e.g., 1, 5, 10, 20, 100, 500 seconds etc.) or via other trigger conditions (e.g., network command, location, time of day, SV detection, etc.) and may be used to crowdsource the GNSS and communication constellation 674, 676 coverage data. For example, observations may include arrays of information such as the GNSS SVs detected (e.g., NS[ ]), the communication SVs detected (SN[ ]), signal strengths, and computed ranges. Other SV parameters may also be observed. In an example, the UEs 652, 654, 656 may also store terrestrial and satellite network information such as station identifications for the respective serving stations at the time of the observations. The UEs 652, 654, 656 may provide their respective observation data to the measurement history database 670 via the respective network and/or sidelink connections. The server 668 and/or measurement history data base 670 may utilize the observation data and SV ephemeris data 672 in one or more machine learning, neural network, and/or federated learning schemas to correlate the signal information with satellite locations. Since the SV ephemeris data is known, the machine learning models may be used to generate an observation forecasts for different locations and times. The resulting observation forecasts (e.g., heat maps) may be provided to network stations and used to determine if a satellite communication network will be accessible at a given location and time.

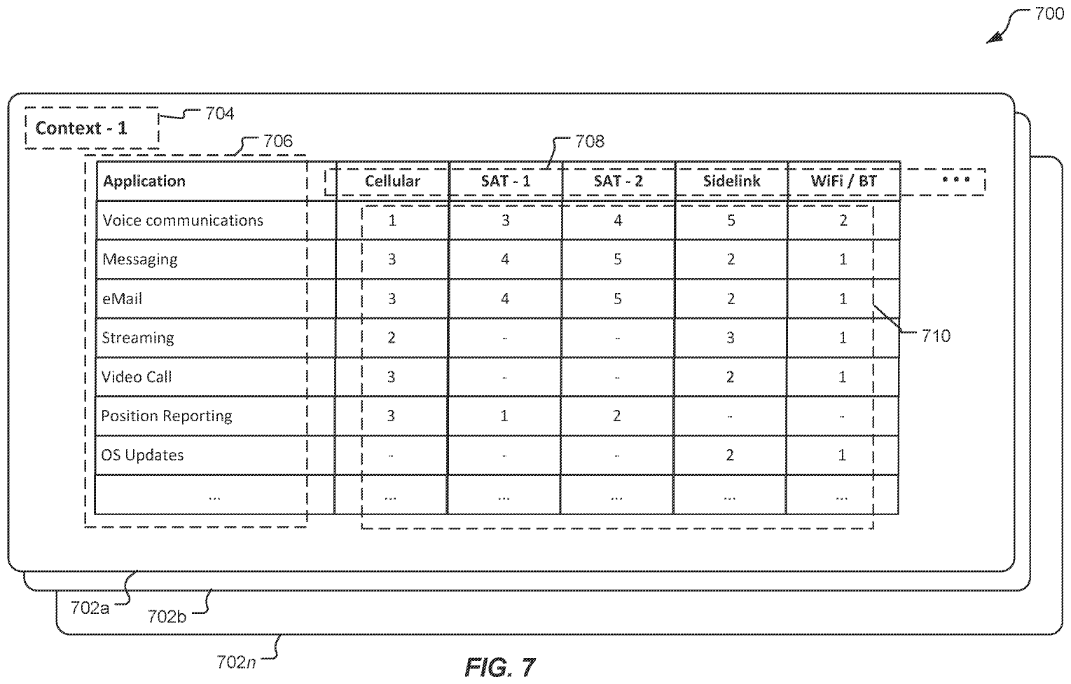

Referring to FIG. 7, an example data structure 700 for network prioritization is shown. The data structure 700 may persist on the UE 200 or server 400, and may include relational database applications (e.g., Oracle, SQL, dBase, etc.), flat files (e.g., JSON, XML, CVS), binary files, look-up-tables, or other file structures configured to persist and index context based prioritization models. The data structure 700 may include other instructions such as stored procedures configured to query, update, append and index the records in the data structure 700. In an example, the data structure may include a plurality of records 702a, 702b, . . . 702n including context, application, network and prioritization information. One or more context fields 704 may be used to identify discreet operational environment and/or system states which may be associated with prioritization values. As examples, and not limitations, the context values may be used to classify whether a UE is located in an indoor location, an outdoor location, densely populated location, sparsely populated location, weather conditions (e.g., severe rain/storms which impact RF propagation), the quality, availability, and types of network signals received by the UE, power status (e.g., charge, external supply), active and sleep modes, relative location to a user, the presence of peripheral devices which may impact RF signals (e.g., external antennas, card/chip readers, device covers, etc.). Other operational environment and/or system state parameters may be used to describe the context. In an example, one or more defined context values may be grouped into a context class with a unique index. The context field 704 may be associated with such a context class index (i.e., one or more of the records 702a, 702b . . . 702n may be associated with each of the contexts in the context class).

In an embodiment, each record 702a, 702b . . . 702n may include a context field 704, and one or more applications 706 and a plurality of potential networks 708, with the combinations of applications and networks including priority values 710. The applications 706 indicate the potential applications executing on a UE which may utilize network data services. The potential networks 708 indicate the wireless communication networks which the UE may utilize (e.g., based on hardware and subscriber configurations). The priority values 710 may represent an order of network preference for each of the potentially available networks 708 which the UE may use for communication. In an example, a record may include one list of priority values (e.g., one application 706) which may be used to prioritize communications for all applications executing on the UE. In another example, a record may include a plurality of applications 706, and each application may be associated with the same or different network priority values. For example, the UE may be configured to utilize one network for voice communications (e.g., a cellular network), and another network for messaging (e.g., a satellite network), and another for streaming video (e.g., a WiFi network). Other combinations or networks and applications are possible. The priority values 710 may be based on user preferences to ensure continuous coverage (e.g., mission critical communications), or to maximize bandwidth and/or minimize bandwidth usage charges. Other commercial and personal preference factors may be used to determine the priority values. In an embodiment, the UE may include a user interface to enable a user to enter or select the context, application(s), networks and the associated priority values. In an example, a network entity such as the LMF 120 or the BS 160 may be configured to provide the data structure 700 and corresponding context, application, network and priority values to a UE via standard messaging (e.g., NRPPa. RRC, etc.). The network entity may be configured to modify the priority values based on network demand metrics. For example, in periods of high demand on a satellite network, the BS 160 may be configured to update the data structure 700 to reduce the priority of email and messaging applications on the satellite network, and increase the priority for those applications on another network (e.g., cellular or WiFi). Upon receiving the updated data structure, the UE may be configured to attempt to change networks for those applications if the indicated networks are available. The UE may be configured to provide the user a notification message to indicate the change in priority and/or network connection. The network reconfiguration may occur automatically, or may require user approval. Other network parameters may be used to reconfigure the priority values on the UE.

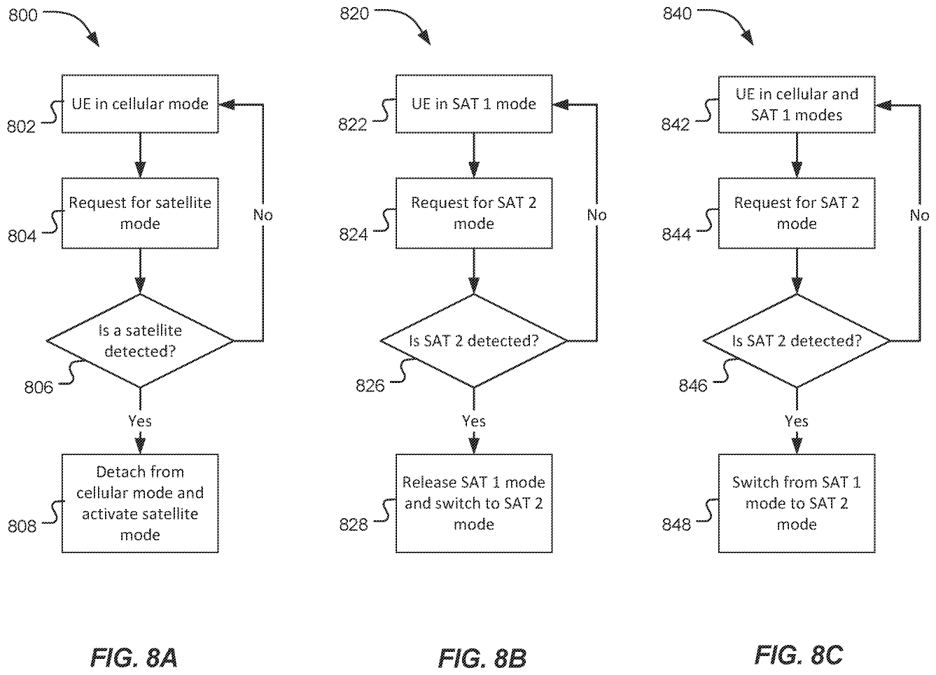

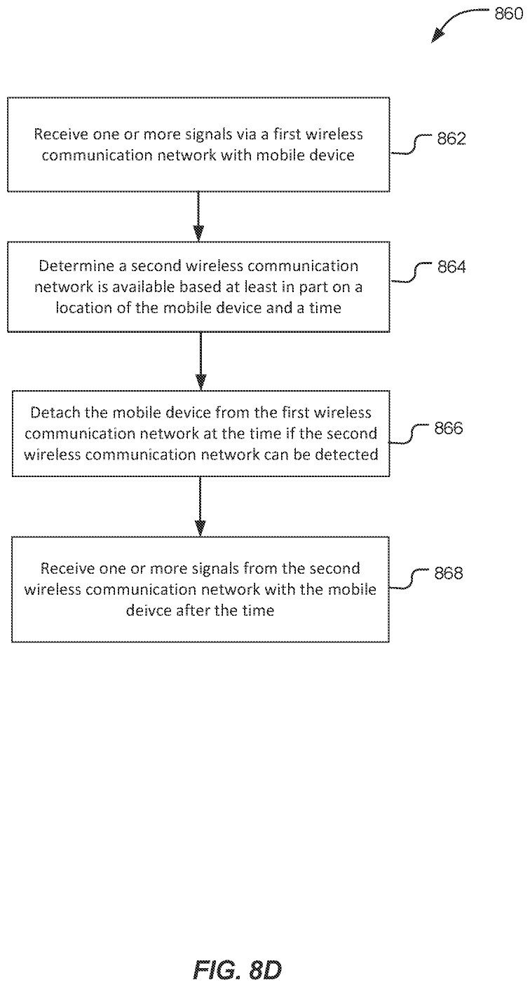

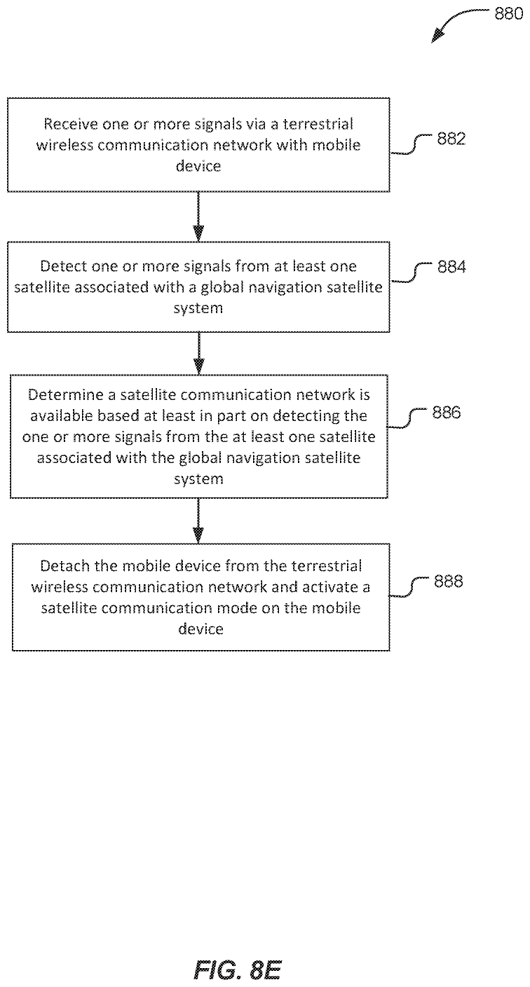

Referring to FIGS. 8A-8E, example methods for switching between cellular and satellite communication systems are shown. In a first method 800, at stage 802 a UE, such as the UE 505 in FIG. 5A, may be in a cellular mode and communicating with a base station, such as the base station 502. At stage 804, the user of, or an application executing on, the UE 505 may request a change from cellular to satellite mode. For example, a navigation application may be used to trigger a change from the cellular to the satellite network based on the trajectory 506 relative to the coverage areas 502a, 504a. In an example, a Quality of Service (QoS) parameter associated with the cellular communications may be used to request the change at stage 804. For example, a decrease in the QoS may be used to trigger the switch. In an embodiment, the request may be for all services (e.g., voice and data). In another embodiment, the request may be limited to one or more applications such that some applications may continue to use the cellular network and others may utilize the satellite network. For example, the execution of an application on the UE with a different priority value for the current network may trigger a request for the satellite mode at stage 804. At stage 806, the UE 505 may determine if a satellite network is likely to be detected. In an example, the UE 505 may determine a current context and base the determination on the current context (e.g., an indoor context indicates that satellite communications are unlikely). The UE 505 may be configured to receive a SV observation forecast from a network, such as described in FIG. 6B, and determine if the satellite network is likely to be detected based on the observation forecast. In an embodiment, the UE 505 may be configured to perform a search for a satellite network concurrently while connected to the cellular network. If a satellite is detected, or likely to be detected, at stage 808, the UE 505 may detach from the cellular mode and activate a satellite mode. The mode change may be for the entire UE 505 (e.g., all voice and data services), or limited to one or more applications. The application and mode selection may be based on the priority values as described in FIG. 7.

In a second method 820, at stage 822 a UE, such as the UE 505 in FIG. 5B, may be in a first satellite communication mode and communicating with a first SV, such as the first SV 504. At stage 824, the user of, or an application executing on, the UE 505 may request a change from the first satellite mode to a second satellite mode. For example, a navigation application may be used to trigger a change from the first satellite network to the second satellite network based on the trajectory 526 relative to the coverage areas 504a, 524a. In an example, a QoS parameter associated with the communications on the first satellite network may be used to request the change at stage 824. In an embodiment, the request may be for all services (e.g., voice and data). In another embodiment, the request may be limited to one or more applications such that some applications may continue to use the first satellite network and others may utilize the second satellite network. For example, the execution of an application on the UE with a different priority value for the first satellite network may trigger a request for the second satellite mode at stage 824. At stage 826, the UE 505 may determine if the second satellite network is likely to be detected. In an example, the UE 505 may determine a current context and base the determination on the current context (e.g., if the UE 505 is located outside the coverage are 506a, then communication with the second satellite network is unlikely). The UE 505 may be configured to receive a SV observation forecast including SVs from the second satellite network, such as described in FIG. 6B, and determine if the second satellite network is likely to be detected based on the observation forecast. In an example, the UE 505 may be configured to perform a search for the second satellite network concurrently while connected to the first satellite network. If the second satellite network is detected, or likely to be detected, at stage 828, the UE 505 may release from the first satellite mode and switch to the second satellite mode. The mode change may be for the entire UE 505 (e.g., all voice and data services), or limited to one or more applications. Priority values may be used to determine which applications utilize the first or second satellite communication networks.

In a third method 840, various combinations of networks may be used and a UE may be configured to modify the network modes based on the availability of different networks. For example, at stage 842 a UE, such as the vehicle 545 in FIG. 5C, may be in a cellular mode and a first satellite mode and capable of communicating with the base station 502 and the a first SV, such as the first SV 504. At stage 844, the user of, or an application executing on, the UE 505 may request a change from the first satellite mode to a second satellite mode without detaching the cellular mode. At stage 846, the UE 505 may determine if the second satellite network is likely to be detected. In an example, the UE 505 may determine a current context such as determining the coverage areas for the first and second satellite systems based on a heat map (e.g., an observation forecast). In an example, the UE 505 may be configured to perform a search for the second satellite network concurrently while connected to the cellular network and the first satellite network. If the second satellite network is detected, or likely to be detected, at stage 848, the UE 505 may release from the first satellite mode and switch to the second satellite mode while maintaining the cellular mode connection.

In a fourth method 860, at stage 862 a UE may receive one or more signals via a first wireless communication network. For example, the UE may be communicating with a cellular network via a base station, or with a satellite communication network via a SV. The one or more signals may be received during normal voice and/or data communications with the first wireless communication network. At stage 864, the UE may determine if a second wireless communication network is available based at least in part on a location of the UE and a time. In an example, the second wireless communication network may be a satellite communication network. The location and time may be the current location of the UE at the current or future time, or a future location at a future time. A navigation application executing on the UE may be used to determine the future location and time. In an example, the UE may be configured to receive a SV observation forecast indicating the locations and times the second wireless communication network may be detected. If the second communication network is available (e.g., it can be detected), then at stage 866, the UE may detach from the first wireless communication network mode and switch to the second wireless communication network. At stage 868, the UE may receive one or more signals from the second wireless communication network. The one or more signals may include standard registration and/or voice or data signals between the UE and a station (e.g., an SV) in the second wireless communication network.

In a fifth method 880, at stage 882, a UE may receive one or more signals via a terrestrial wireless communication network. For example, the UE may be communicating with a cellular network via a base station, or a V2X network via sidelink (e.g., PC5 with a RSU). The one or more signals may be received during voice and/or data communications via the terrestrial network. At stage 884, the UE may detect one or more signals from at least on satellite associated with a global navigation satellite system. For example, the UE may utilize the SPS receiver 217 to detect the one or more signals. In an embodiment, the presence of the GNSS signals may be used as an indication that the UE is in an location with an unobstructed view to a LEO satellite constellation. In an embodiment, the one or more signals may be characterized based on a satellite identification (SVID) code, such as a pseudo-random noise (PRN) code, and the presence of certain SVIDs or combinations of SVID may be detected. At stage 886, the UE may determine a satellite communication network is available based at least in part on detecting the one or more signals from the at least one satellite associated with global navigation satellite system. In an embodiment, the detection of a SVID from a GNSS may be sufficient to determine that a satellite communication network is available. In an example, the UE may utilize a look-up-table or other data structure to determine if a satellite communication network is available based on detected GNSS signals. The data structure may be stored locally on the UE, or on a network resource (e.g., a location server) and available to the UE. The look-up-table may be based on a satellite coverage observation forecast such as described in FIG. 6B. Other functions or models may also be used to determine a satellite communication network is available based on the detection of GNSS SVs. At stage 888, the UE may detach from the terrestrial wireless communication network and activate a satellite communication mode. For example, the UE may include one or more satellite transceivers 280 configured to operate with satellite communication networks such as Inmarsat, Iridium, Thuraya, and/or Globalstar. Since the UE determined that the satellite communication network was available at stage 886 (i.e., based on detecting the GNSS signals at stage 884), the UE may avoid prematurely detaching from the terrestrial network when the satellite communication network is not available due to obstructions or other variations in coverage areas.

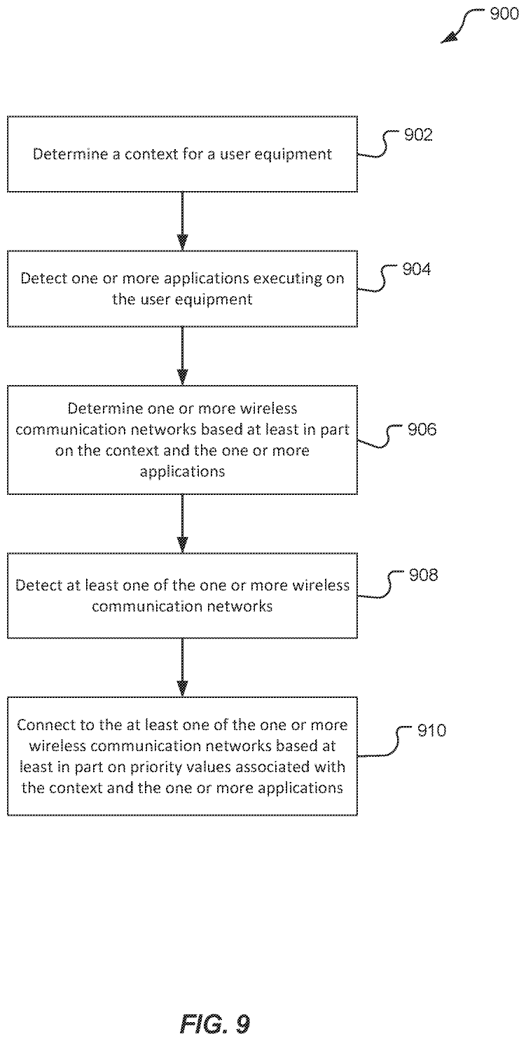

Referring to FIG. 9, with further reference to FIGS. 1-8E, a method 900 for connecting to a wireless communication network includes the stages shown. The method 900 is, however, an example and not limiting. The method 900 may be altered, e.g., by having stages added, removed, rearranged, combined, performed concurrently, and/or having single stages split into multiple stages.

At stage 902, the method includes determining a context for a user equipment. The UE 200 is a means for determining a context. The context of the UE describes the current operational environment and may also consider the current state of the UE. In an example, the context of the UE may be based on a geographic location, a general location (e.g., indoor/outdoor), proximate geography (e.g., open space, canyon, tunnel), density of network devices (e.g., sparse areas such as a rural neighborhood, dense areas such as a sports stadium), or other defined operational environments. Other factors such as time, date, presence of peripheral devices, and equipment state parameters such as power level, the status of receive and transmit processor stacks, sleep mode, the detection of radio signals, QoS of a current network, and user preferences may define the context. Other sensors such as RF sensing, radar, lidar, optical sensors, proximity sensors may be used to determine the context. For example, RF sensing may be used to determine if the UE is located indoors. GNSS signal strength may be used to determine if the LOS to a region of the sky is obstructed. In operation, the context of the UE may be associated with one or more records in the data structure 700.

At stage 904, the method includes detecting one or more applications executing on the user equipment. The UE 200 is a means for detecting the one or more applications. The applications may be configured to utilize data connections associated with a network and/or the internet. For example, voice, email, messaging, streaming, video conferencing, operation system updates, and other applications may obtain data via a communication network. The UE may be configured to manage processor resources and monitor the active applications.

At stage 906, the method includes determining one or more wireless communication networks based at least in part on the context and the one or more applications. The UE 200 is a means for determining the one or more wireless communication networks. In an example, referring to FIG. 7, the context determined at stage 902 may be used to select one or more records 702a, 702b . . . 702n in the data structure 700. The one or more wireless networks may be based on the potential networks 708 associated with the context 704 and the applications 706 determined at stage 904.

At stage 908, the method includes detecting at least one of the one or more wireless communication networks. The UE 200 is a means for detecting the one or more wireless communication networks. In an example, the UE 200 may be configured to receive heat map data associated with the coverage areas of the potential networks 708. The heat map data may be, for example, an observation forecast for one or more satellite networks indicating times and locations that a satellite network may be utilized. Identifying a valid time and location for a satellite network on the observation forecast may be detecting a wireless network. In another example, the UE 200 may be configured to perform active scans to detect one or more of the networks in the potential networks 708 based on the executing applications 708.

At stage 910, the method includes connecting to the at least one of the one or more wireless communication networks based at least in part on priority values associated with the context and the one or more applications. The UE 200 is a means for connecting to the at least one of the wireless communication networks. The data structure 700 may include a plurality of priority values 710 associated with the context 704, the applications 706, and the potential networks 708. If multiple wireless networks are available, and the UE 200 is configured to utilize one wireless network, the UE may select the potential networks 708 based on priority values 710 associated with the applications 706. In an example, the priority values 710 may be weighted based on usage history (e.g., messaging services may be weighted higher when the user has a history of texting as compared to using voice communications). If the UE 200 is configured to utilize multiple networks simultaneously, then the networks may be selected based on the executing applications and the priority values 710. For example, the first record 702a indicates that for a first context (i.e., Context-1), cellular is the preferred connection for voice communications (i.e., priority=1) and WiFi/BT is the preferred connection for messaging, eMail, streaming, video call, and OS update applications. Other records 702b . . . 702n may have different network priorities for different applications.

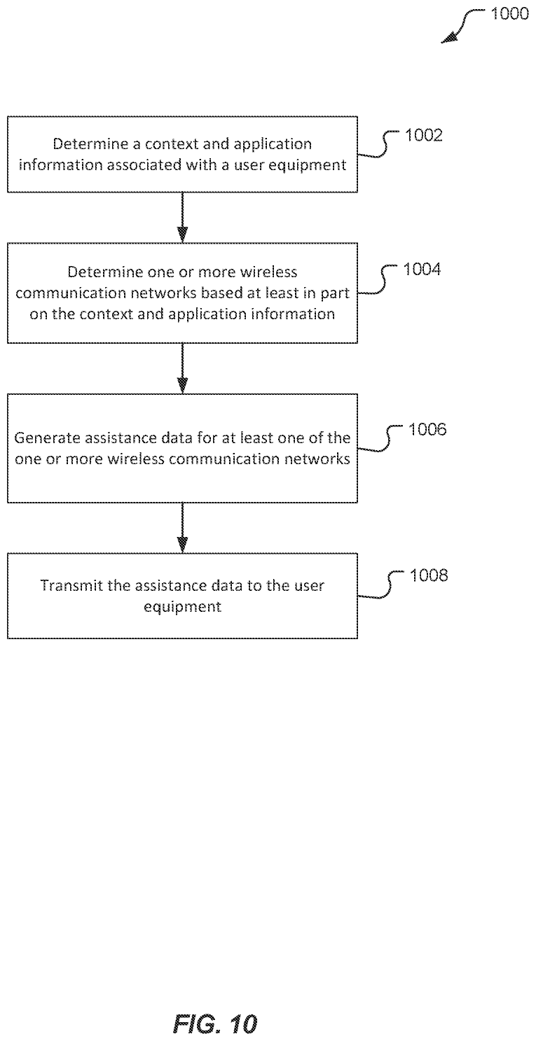

Referring to FIG. 10, with further reference to FIGS. 1-8E, a method 1000 for providing assistance data to a user equipment includes the stages shown. The method 1000 is, however, an example and not limiting. The method 1000 may be altered, e.g., by having stages added, removed, rearranged, combined, performed concurrently, and/or having single stages split into multiple stages.

At stage 1002, the method includes determining a context and application information associated with a user equipment. A server 400, such as the LMF 120 and the network control module 162, is a means for determining context and application information for the UE. In an example, the data structure 700 for a UE may persist on a network server and the server may be configured to obtain records 702a, 702b . . . 702n associated with the UE based on identification information such as a UE ID. The UE may be configured to provide one or more request assistance messages including identification and context information, and the server may utilize the request assistance messages to determine the context and application information based on the data structure 700. Other information in the request for assistance data messages may be used to determine the context of the UE. In an embodiment, the server may be configure to determine the context of the UE, for example, based on the location and/or trajectory of the UE. The context and the UE identification information may be used to determine one or more records in the data structure 700.

At stage 1004, the method includes determining one or more wireless communication networks based at least in part on the context and application information. The server 400 is a means for determining the one or more wireless communication networks. The server may utilize the potential networks 708 in a record 702a, 702b . . . 702n as the one or more wireless communication networks. That is, if a potential network 708 is associated with a priority value 710, then the server may include the potential networks in the one or more wireless communication networks. In an embodiment, a UE may provide request assistance messages including an indication of the executing or preferred application, and the server may limit the one or more wireless communication networks to the potential networks 708 based on the indicated preferred or executing applications.

At stage 1006, the method includes generating assistance data for at least one of the one or more wireless communication networks. The server 400 is a means for generating the assistance data. In an example, the one or more wireless communication networks may include terrestrial networks such as WiFi and cellular (e.g., LTE, 5G NR, etc.), and satellite based technologies. The assistance data may include protocol, credential, timing, interface, ephemeris, or other information to enable the UE to join the wireless network. In an example, the assistance data may include information for joining several wireless networks using the same or different radio access technologies (e.g., a first satellite network and a second satellite network). In an example, the server may be configured to provide assistance data in an effort to reduce network load. For example, if traffic on a satellite network must be reduced, then the server may provide assistance data to enable some UEs to bifurcate voice and data applications between the satellite network and terrestrial network resources. The assistance data may be based on the priority value associated with terrestrial based potential network options 708.

At stage 1008, the method includes transmitting the assistance data to the user equipment. A base station 502 or SV 504 are example means for transmitting the assistance data. In an example, a cellular network may be configured to provide assistance data based messaging protocols such as LPP, NRPPa, RRC, etc. A satellite system may use proprietary messaging formats to transmit the assistance data. In general, the assistance data may arrive via a first communication network to enable a UE to connect to a second communication network.

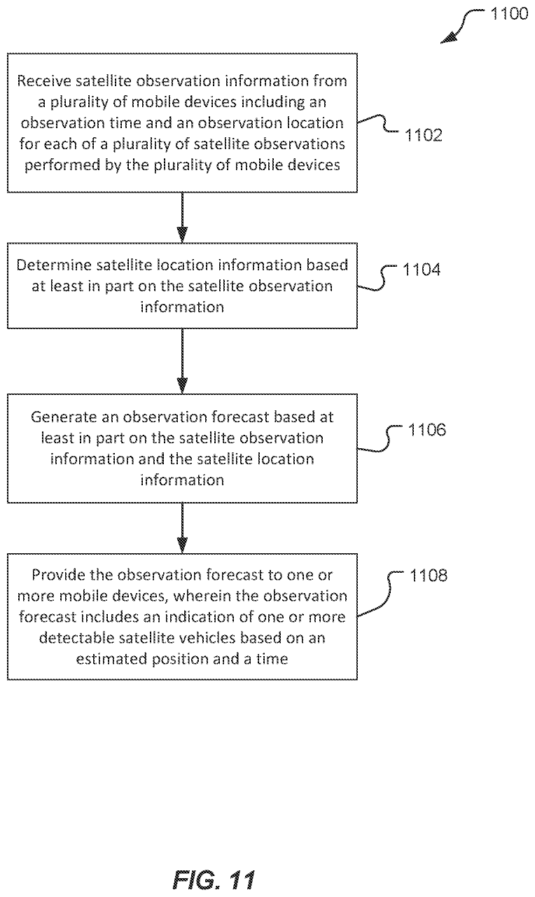

Referring to FIG. 11, with further reference to FIGS. 1-8E, a method 1100 for providing satellite coverage forecasts includes the stages shown. The method 1100 is, however, an example and not limiting. The method 1100 may be altered, e.g., by having stages added, removed, rearranged, combined, performed concurrently, and/or having single stages split into multiple stages.

At stage 1102, the method includes receiving satellite observation information from a plurality of mobile devices including an observation time and an observation location for each of a plurality of satellite observations performed by the plurality of mobile devices. A server 400, such as the server 668, or a UE 200, such as the UE 654 are means for receiving the satellite observation information. In an embodiment, referring to FIG. 6B, a plurality of UEs may obtain satellite signals from different locations and at different times. For example, the UEs 652, 654, 656 may be configured to obtain satellite observation information at their respective locations 652a. 654a. 656a (e.g., L1, L2, L3) and at respective times (e.g., tx, ty, tz). The observations may be obtained periodically or via other trigger conditions, and may be used to crowdsource the GNSS and communication constellation 674, 676 coverage data. For example, observations may include arrays of information such as the identification of GNSS SVs detected (e.g., NS[ ]), the identification of communication SVs detected (SN[ ]), signal strengths, and computed ranges. Other SV parameters may also be observed. The UEs may utilize network connections to provide the observation information to the server 668 and the measurement history database 670. In an embodiment, a UE 200 may obtain satellite observation information locally and not transmit the observation information to a network server. That is, the UE may use a federated learning schema to process the observation data obtained by the UE.

At stage 1104, the method includes determining satellite location information based at least in part on the satellite observation information. The server 400 is a means for determining the satellite location information. In an example, the locations of SVs in GNSS and communication networks are known or may be plotted based on ephemeris data 672. The server 668 may be configured to utilize the identification and time information in the satellite observation information received at stage 1102 to determine the location of the respective SVs.

At stage 1106, the method includes generating an observation forecast based at least in part on the satellite observation information and the satellite location information. The server 400 is a means for generating the observation forecast. In general, the observation forecast may be used by a UE to determine if a satellite connection may be used at a given location and time. The observation forecast may also reduce the search time required to identify signals transmitted from SVs in a network. In an example, a supervised machine learning module may utilize the satellite locations as training data and the labels may be the parameters in the corresponding observation information. Other machine learning schema may also be used. For example, an unsupervised learning method may utilize clustering, dimensionality reduction, anomaly detection, and/or association rule-mining based on the satellite observation information and the satellite location information received from a plurality of UEs. Other modeling methods such as neural networks and federated learning may be used to generate the observation forecast. For example, each of the UEs may be configured to maintain their respective satellite observation information and utilize machine learning to determine an observation forecast. Other edge techniques may also be used. In an example, the UEs may be configured to update the observation forecast based on actual results and may return the updated forecast to the server 668 and the server may be configure to update the observation forecast model.

At stage 1108, the method includes providing the observation forecast to one or more mobile devices, wherein the observation forecast includes an indication of one or more detectable satellite vehicles based on an estimated position and a time. The server 400 and the UE 200 are example means for providing the observation forecast. In an embodiment, the server 668 or another edge server, may be configured to provide the observation forecast to the UEs as assistance data via wireless network protocols (e.g., LPP, NRPP, RRC, etc.), or proprietary satellite protocols. In a V2X network, referring to FIG. 5C, the RSU 542 may receive the observation forecast via a wired or wireless connection (e.g., a Uu interface) and may provide the observation forecast to one or more UEs via a sidelink protocol (e.g., PC5).

In an embodiment, the UEs may be configured to provide their locally generated observation forecast (e.g., in a federated learning schema), or provide observation forecasts received from the server 668, to other network stations via sidelink technologies (e.g., PC5). The use of the sidelink between different UEs may enable more real-time communication of whether the SVs may be seen by other UEs in the area. In an example, the estimated position and time may be the current location of the UE and the current or future time. The estimate position may also be a future location and a future time based on a trajectory of the UE.

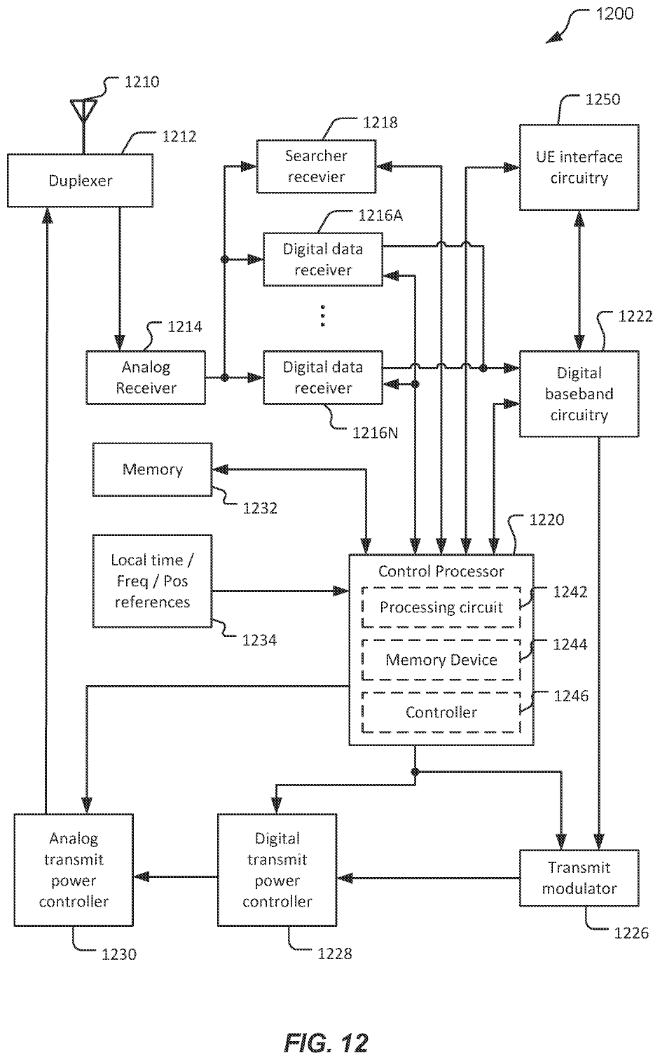

Referring to FIG. 12, an example of a satellite transceiver 1200 is shown. The satellite transceiver 1200 may be an example of the satellite transceiver 280 in the UE 200. The satellite transceiver 1200 includes at least one antenna 1210 for receiving forward link communication signals (e.g., from the satellite 504), which are transferred to an analog receiver 1214, where they are down-converted, amplified, and digitized. A duplexer element 1212 may be used to allow the same antenna to serve both transmit and receive functions. Alternatively, the satellite transceiver 1200 may use separate antennas for operating at different transmit and receive frequencies. The digital communication signals output by the analog receiver 1214 are transferred to at least one digital data receiver 1216A and at least one searcher receiver 1218. Additional digital data receivers (e.g., as represented by a digital data receiver 1216N) may be used to obtain desired levels of signal diversity, depending on the acceptable level of transceiver complexity. At least one user terminal control processor 1220 is coupled to the digital data receivers 1216A-1216N and the searcher receiver 1218. The control processor 1220 may provide, among other functions, basic signal processing, timing, power and handoff control or coordination, and selection of frequency used for signal carriers. Another basic control function that may be performed by the control processor 1220 is the selection or manipulation of functions to be used for processing various signal waveforms. Signal processing by the control processor 1220 may include a determination of relative signal strength and computation of various related signal parameters. Such computations of signal parameters, such as timing and frequency may include the use of additional or separate dedicated circuitry to provide increased efficiency or speed in measurements or improved allocation of control processing resources.

The outputs of the digital data receivers 1216A-1216N are coupled to digital baseband circuitry 1222 within the UT 1200. The digital baseband circuitry 1222 includes processing and presentation elements used to transfer information to and from the UE 200 as shown in FIG. 2, for example. Referring to FIG. 12, if diversity signal processing is used, the digital baseband circuitry 1222 may include a diversity combiner and decoder (not shown). Some of these elements may also operate under the control of, or in communication with, a control processor 1220. When voice or other data is prepared as an output message or a communication signal originating with the satellite transceiver 1200, the digital baseband circuitry 1222 may be used to receive, store, process, and otherwise prepare the desired data for transmission. The digital baseband circuitry 1222 provides this data to a transmit modulator 1226 operating under the control of the control processor 1220. The output of the transmit modulator 1226 is transferred to a power controller 1228 which provides output power control to a transmit power amplifier 1230 for final transmission of the output signal from the antenna 1210 to a satellite (e.g., the satellite 504).

The satellite transceiver 1200 may also include a memory 1232 associated with the control processor 1220. The memory 1232 may include instructions for execution by the control processor 1220 as well as data for processing by the control processor 1220. The memory 1232 may include instructions for performing time or frequency adjustments to be applied to an RF signal to be transmitted by the satellite transceiver 1200 via the return service link to the satellite 504. The satellite transceiver 1200 may also include optional local time, frequency and/or position references 1234 (e.g., a GPS receiver), which may provide local time, frequency and/or position information to the control processor 1220 for various applications, including, for example, time or frequency synchronization for the satellite transceiver 1200. In an embodiment, these functions may be performed by the SPS receiver 217 in the UE 200. The digital data receivers 1216A-1216N and the searcher receiver 1218 may be configured with signal correlation elements to demodulate and track specific signals. The searcher receiver 1218 is used to search for pilot signals, or other relatively fixed pattern strong signals, while the digital data receivers 1216A-1216N are used to demodulate other signals associated with detected pilot signals. However, a digital data receiver 1216 can be assigned to track the pilot signal after acquisition to accurately determine the ratio of signal chip energies to signal noise, and to formulate pilot signal strength. Therefore, the outputs of these units can be monitored to determine the energy in, or frequency of, the pilot signal or other signals. These receivers also use frequency tracking elements that can be monitored to provide current frequency and timing information to the control processor 1220 for signals being demodulated. In an embodiment, the control processor 1220 may use such information to determine to what extent the received signals are offset from the oscillator frequency, when scaled to the same frequency band, as appropriate. This and other information related to frequency errors and frequency shifts can be stored in a storage or memory element (e.g., the memory 1232) as desired. The control processor 1220 may also be coupled to the UE interface circuitry 1250 to allow communication between the satellite transceiver 1200 and the one or more application processors 230. The UE interface circuitry 1250 may be configured as desired for communication with various UE configurations and accordingly may include various transceivers and related components depending on the various communication technologies used by the UE 200. The control processor 1220 may include one or more of a processing circuit 1242, a memory device 1244, or a controller 1246 that independently or cooperatively perform location reporting-related operations and/or paging-related operations for the satellite transceiver 1200. In an example implementation, the processing circuit 1242 may be configured (e.g., programmed) to perform some or all of these operations. In another example implementation, the processing circuit 1242 (e.g., in the form of a processor) executes code stored in the memory device 1244 to perform some or all of these operations. In another example implementation, the controller 1246 (e.g., including application specific logic) is configured (e.g., programmed) to perform some or all of these operations. Although depicted in FIG. 12 as included within the control processor 1220, for other implementations, one or more of the processing circuit 1242, the memory device 1244, or the controller 1246 may be a separate subsystem that is coupled to the control processor 1220.

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations. For example, one or more functions, or one or more portions thereof, discussed above as occurring in the LMF 120 may be performed outside of the LMF 120 such as by the TRP 300 or the base station 160.

Components, functional or otherwise, shown in the figures and/or discussed herein as being connected or communicating with each other are communicatively coupled unless otherwise noted. That is, they may be directly or indirectly connected to enable communication between them.

As used herein, unless otherwise stated, a statement that a function or operation is “based on” an item or condition means that the function or operation is based on the stated item or condition and may be based on one or more items and/or conditions in addition to the stated item or condition.

As used herein, the singular forms “a,” “an,” and “the” include the plural forms as well, unless the context clearly indicates otherwise. For example, “a processor” may include one processor or multiple processors. The terms “comprises,” “comprising,” “includes.” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C.” or a list of “one or more of A, B. or C” or a list of “A or B or C” means A. or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item. e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure). Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly. Further, the term “wireless communication device,” or similar term, does not require that the functionality of the device is exclusively, or evenly primarily, for communication, or that the device be a mobile device, but indicates that the device includes wireless communication capability (one-way or two-way), e.g., includes at least one radio (each radio being part of a transmitter, receiver, or transceiver) for wireless communication.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations, and does not limit the scope, applicability, or configurations of the claims. Rather, the preceding description of the configurations provides a description for implementing described techniques. Various changes may be made in the function and arrangement of elements without departing from the scope of the disclosure.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value. e.g., the second threshold value being one value lower than the first threshold value in the resolution of a computing system.

Implementation examples are described in the following numbered clauses:

Clause 1. A method for switching between communication networks, comprising; receiving one or more signals via a first wireless communication network with a mobile device; determining a second wireless communication network is available based at least in part on a location of the mobile device and a time; detaching the mobile device from the first wireless communication network at the time if the second wireless communication network is available; and receiving one or more signals from the second wireless communication network with the mobile device after the time.

Clause 2. The method of clause 1 wherein determining the second wireless communication network is available includes determining a context for the mobile device.

Clause 3. The method of either clause 1 or 2 wherein the first wireless communication network is a cellular network and the second wireless communication network is a satellite network.

Clause 4. The method of any of clauses 1-3 wherein the first wireless communication network is a first satellite network and the second wireless communication network is a second satellite network.

Clause 5. The method of clause 4 further comprising receiving one or more signals from a cellular network concurrently with receiving one or more signals on the first wireless communication network, and receiving one or more signals from the cellular network concurrently with receiving one or more signals on the second wireless communication network.

Clause 6. The method of any of clauses 1-5 wherein determining the second wireless communication network is available includes determining that the location of the mobile device at the time is within a coverage area of second wireless communication network.

Clause 7. The method of any of clauses 1-6 further comprising receiving a satellite observation forecast, wherein determining the second wireless communication network is available is based on an indication of one or more detectable satellite vehicles at the location and the time.

Clause 8. The method of clause 7 wherein the satellite observation forecast is received from a network station.

Clause 9. The method of clause 7 wherein the satellite observation forecast is received from a proximate user equipment via a sidelink.

Clause 10. The method of any of clauses 1-9 further comprising providing satellite observation information to a network server, wherein the satellite observation information is based on signals received from the first wireless communication network, the second wireless communication network, or both.

Clause 11. A method of communicating on a wireless network, comprising: determining a context for a user equipment: detecting one or more applications executing on the user equipment; determining one or more wireless communication networks based at least in part on the context and the one or more applications; detecting at least one of the one or more wireless communication networks; and connecting to the at least one of the one or more wireless communication networks based at least in part on priority values associated with the context and the one or more applications.

Clause 12. The method of clause 11 wherein determining the context for the user equipment is based on determining the user equipment is located within a structure.

Clause 13. The method of either clauses 11 or 12 wherein the one or more wireless communication networks include a cellular network and a satellite communication network.

Clause 14. The method of any of clauses 11-13 wherein the one or more wireless communication networks include a first satellite communication network and a second satellite communication network.

Clause 15. The method of any of clauses 11-14 wherein the one or more wireless communication networks include a Wi-Fi network and a satellite communication network.

Clause 16. The method of any of clauses 11-15 wherein the one or more wireless communication networks include a sidelink based network and a satellite communication network.

Clause 17. The method of any of clauses 11-16 wherein the one or more applications executing on the user equipment include at least one of a voice communication application, a messaging application, an email application, a media streaming application, a video calling application, a meeting application, or a navigation application.

Clause 18. The method of any of clauses 11-17 further comprising connecting to a first wireless network and a second wireless network, wherein a first of the one or more applications is configured to utilize the first wireless network and a second of the one or more applications is configured to utilize the second wireless network.

Clause 19. The method of clause 18 wherein the first wireless network is a cellular network and the second wireless network is a satellite communication network.

Clause 20. The method of clause 18 wherein the first wireless network is a sidelink based network and the second wireless network is a satellite communication network.

Clause 21. The method of clause 18 wherein the first wireless network is a first satellite communication network and the second wireless network is a second satellite communication network.

Clause 22. A method of providing satellite coverage forecasts, comprising: receiving satellite observation information from a plurality of mobile devices including an observation time and an observation location for each of a plurality of satellite observations performed by the plurality of mobile devices; determining satellite location information based at least in part on the satellite observation information: generating an observation forecast based at least in part on the satellite observation information and the satellite location information; and providing the observation forecast to one or more mobile devices, wherein the observation forecast includes an indication of one or more detectable satellite vehicles based on an estimated position and a time.

Clause 23. The method of clause 22 wherein the satellite observation information includes observations of signals transmitted by one or more satellite vehicles in a global navigation satellite system.

Clause 24. The method of either of clauses 22 or 23 wherein the satellite observation information includes observations of signals transmitted by one or more satellite vehicles in a satellite communication network.

Clause 25. The method of any of clauses 22-24 wherein generating the observation forecast includes utilizing one or more machine learning methods with the satellite location information as training data and the satellite observation information as labels.

Clause 26. The method of any of clauses 22-25 wherein providing the observation forecast includes transmitting the observation forecast in assistance data via a cellular communication messaging protocol.

Clause 27. The method of any of clauses 22-26 wherein providing the observation forecast includes transmitting the observation forecast in assistance data via a sidelink communication messaging protocol.

Clause 28. A method for switching between communication networks, comprising: receiving one or more signals via a terrestrial wireless communication network with a mobile device; detecting one or more signals from at least one satellite associated with a global navigation satellite system; determining a satellite communication network is available based at least in part on detecting the one or more signals from the at least one satellite associated with the global navigation satellite system; and detaching the mobile device from the terrestrial wireless communication network and activating a satellite communication mode on the mobile device.

Clause 29. The method of clause 28 wherein detecting the one or more signals from the at least one satellite includes detecting a satellite identification code.

Clause 30. The method of either of clauses 28 or 29 wherein determining the satellite communication network is available includes querying a data structure based on the one or more signals from the at least one satellite.

Clause 31. The method of clause 30 wherein the data structure is stored on a network server and the mobile device is configured to query the data structure via the terrestrial wireless communication network.

Clause 32. The method of any of clauses 28-31 further comprising determining a location of the mobile device and transmitting an indication of the one or more signals and the location to a network server.

Clause 33. An apparatus, comprising: a memory; at least one transceiver; at least one processor communicatively coupled to the memory and the at least one transceiver, and configured to: receive one or more signals via a first wireless communication network; determine a second wireless communication network is available based at least in part on a location and a time; detach from the first wireless communication network at the time if the second wireless communication network is available; and receive one or more signals from the second wireless communication network after the time.

Clause 34. The apparatus of clause 33 wherein the at least one processor is further configured to determine a context.

Clause 35. The apparatus of either of clauses 33 or 34 wherein the first wireless communication network is a cellular network and the second wireless communication network is a satellite network.

Clause 36. The apparatus of any of clauses 33-35 wherein the first wireless communication network is a first satellite network and the second wireless communication network is a second satellite network.

Clause 37. The apparatus of clause 36 wherein the at least one processor is further configured to receive concurrently one or more signals from a cellular network and one or more signals via the first wireless communication network, and receive concurrently one or more signals from the cellular network and one or more signals via the second wireless communication network.

Clause 38. The apparatus of any of clauses 33-37 wherein the at least one processor is further configured determine that the location at the time is within a coverage area of second wireless communication network.

Clause 39. The apparatus of any of clauses 33-38 wherein the at least one processor is further configured to receive a satellite observation forecast, and determine the second wireless communication network is available based on an indication of one or more detectable satellite vehicles at the location and the time.

Clause 40. The apparatus of clause 39 wherein the at least one processor is further configured to receive the satellite observation forecast from a network station.

Clause 41. The apparatus of clause 39 wherein the at least one processor is further configured to receive the satellite observation forecast from a proximate user equipment via a sidelink.

Clause 42. The apparatus of any of clauses 33-41 wherein the at least one processor is further configured to provide satellite observation information to a network server, wherein the satellite observation information is based on signals received from the first wireless communication network, the second wireless communication network, or both.

Clause 43. An apparatus, comprising: a memory; at least one transceiver; at least one processor communicatively coupled to the memory and the at least one transceiver, and configured to: determine a context for a user equipment; detect one or more applications executing on the user equipment; determine one or more wireless communication networks based at least in part on the context and the one or more applications; detect at least one of the one or more wireless communication networks; and connect to the at least one of the one or more wireless communication networks based at least in part on priority values associated with the context and the one or more applications.

Clause 44. The apparatus of clause 43 wherein the at least one processor is further configured to determine the user equipment is located within a structure.

Clause 45. The apparatus of either of clauses 43 or 44 wherein the one or more wireless communication networks include a cellular network and a satellite communication network.

Clause 46. The apparatus of any of clauses 43-45 wherein the one or more wireless communication networks include a first satellite communication network and a second satellite communication network.

Clause 47. The apparatus of any of clauses 43-46 wherein the one or more wireless communication networks include a Wi-Fi network and a satellite communication network.

Clause 48. The apparatus of any of clauses 43-47 wherein the one or more wireless communication networks include a sidelink based network and a satellite communication network.

Clause 49. The apparatus of any of clauses 43-48 wherein the one or more applications executing on the user equipment include at least one of a voice communication application, a messaging application, an email application, a media streaming application, a video calling application, a meeting application, or a navigation application.

Clause 50. The apparatus of any of clauses 43-49 wherein the at least one processor is further configured to connect to a first wireless network and a second wireless network, wherein a first of the one or more applications is configured to utilize the first wireless network and a second of the one or more applications is configured to utilize the second wireless network.

Clause 51. The apparatus of clause 50 wherein the first wireless network is a cellular network and the second wireless network is a satellite communication network.

Clause 52. The apparatus of clause 50 wherein the first wireless network is a sidelink based network and the second wireless network is a satellite communication network.

Clause 53. The apparatus of clause 50 wherein the first wireless network is a first satellite communication network and the second wireless network is a second satellite communication network.

Clause 54. An apparatus, comprising: a memory; at least one transceiver; at least one processor communicatively coupled to the memory and the at least one transceiver, and configured to: receive satellite observation information from a plurality of mobile devices including an observation time and an observation location for each of a plurality of satellite observations performed by the plurality of mobile devices; determine satellite location information based at least in part on the satellite observation information; generate an observation forecast based at least in part on the satellite observation information and the satellite location information: and provide the observation forecast to one or more mobile devices, wherein the observation forecast includes an indication of one or more detectable satellite vehicles based on an estimated position and a time.

Clause 55. The apparatus of clause 54 wherein the satellite observation information includes observations of signals transmitted by one or more satellite vehicles in a global navigation satellite system.

Clause 56. The apparatus of either of clause 54 or 55 wherein the satellite observation information includes observations of signals transmitted by one or more satellite vehicles in a satellite communication network.

Clause 57. The apparatus of any of clauses 54-56 wherein the at least one processor is further configured to utilize one or more machine learning methods with the satellite location information as training data and the satellite observation information as labels.

Clause 58. The apparatus of any of clauses 54-57 wherein the at least one processor is further configured transmit the observation forecast in assistance data via a cellular communication messaging protocol.

Clause 59. The apparatus of any of clauses 54-58 wherein the at least one processor is further configured to transmit the observation forecast in assistance data via a sidelink communication messaging protocol.

Clause 60. An apparatus, comprising: a memory; at least one transceiver; at least one processor communicatively coupled to the memory and the at least one transceiver, and configured to: receive one or more signals via a terrestrial wireless communication network; detect one or more signals from at least one satellite associated with a global navigation satellite system; determine a satellite communication network is available based at least in part on detecting the one or more signals from the at least one satellite associated with the global navigation satellite system; and detach from the terrestrial wireless communication network and activating a satellite communication mode.

Clause 61. The apparatus of clause 60 wherein the at least one processor is further configured to detect a satellite identification code.

Clause 62. The apparatus of either clause 60 or 61 wherein the at least one processor is further configured to query a data structure based on the one or more signals from the at least one satellite.

Clause 63. The apparatus of clause 62 wherein the data structure is stored on a network server and the at least one processor is further configured to query the data structure via the terrestrial wireless communication network.

Clause 64. The apparatus of any of clauses 60-63 wherein the at least one processor is further configured to determine a location and transmit an indication of the one or more signals and the location to a network server.

Clause 65. An apparatus for switching between communication networks, comprising; means for receiving one or more signals via a first wireless communication network with a mobile device; means for determining a second wireless communication network is available based at least in part on a location of the mobile device and a time; means for detaching the mobile device from the first wireless communication network at the time if the second wireless communication network is available; and means for receiving one or more signals from the second wireless communication network with the mobile device after the time.

Clause 66. An apparatus for communicating on a wireless network, comprising: means for determining a context for a user equipment; means for detecting one or more applications executing on the user equipment; means for determining one or more wireless communication networks based at least in part on the context and the one or more applications; means for detecting at least one of the one or more wireless communication networks; and means for connecting to the at least one of the one or more wireless communication networks based at least in part on priority values associated with the context and the one or more applications.

Clause 67. An apparatus for providing satellite coverage forecasts, comprising: means for receiving satellite observation information from a plurality of mobile devices including an observation time and an observation location for each of a plurality of satellite observations performed by the plurality of mobile devices; means for determining satellite location information based at least in part on the satellite observation information; means for generating an observation forecast based at least in part on the satellite observation information and the satellite location information; and means for providing the observation forecast to one or more mobile devices, wherein the observation forecast includes an indication of one or more detectable satellite vehicles based on an estimated position and a time.

Clause 68. An apparatus for switching between communication networks, comprising: means for receiving one or more signals via a terrestrial wireless communication network with a mobile device; means for detecting one or more signals from at least one satellite associated with a global navigation satellite system; means for determining a satellite communication network is available based at least in part on detecting the one or more signals from the at least one satellite associated with the global navigation satellite system: and means for detaching the mobile device from the terrestrial wireless communication network and activating a satellite communication mode on the mobile device.

Clause 69. A non-transitory processor-readable storage medium comprising processor-readable instructions configured to cause one or more processors to cause a mobile device to switch between communication networks, comprising: code for receiving one or more signals via a first wireless communication network with the mobile device; code for determining a second wireless communication network is available based at least in part on a location of the mobile device and a time; code for detaching the mobile device from the first wireless communication network at the time if the second wireless communication network is available; and code for receiving one or more signals from the second wireless communication network with the mobile device after the time.

Clause 70. A non-transitory processor-readable storage medium comprising processor-readable instructions configured to cause one or more processors to enable communication on a wireless network, comprising: code for determining a context for a user equipment: code for detecting one or more applications executing on the user equipment; code for determining one or more wireless communication networks based at least in part on the context and the one or more applications; code for detecting at least one of the one or more wireless communication networks; and code for connecting to the at least one of the one or more wireless communication networks based at least in part on priority values associated with the context and the one or more applications.

Clause 71. A non-transitory processor-readable storage medium comprising processor-readable instructions configured to cause one or more processors to provide satellite coverage forecasts, comprising: code for receiving satellite observation information from a plurality of mobile devices including an observation time and an observation location for each of a plurality of satellite observations performed by the plurality of mobile devices: code for determining satellite location information based at least in part on the satellite observation information; code for generating an observation forecast based at least in part on the satellite observation information and the satellite location information; and code for providing the observation forecast to one or more mobile devices, wherein the observation forecast includes an indication of one or more detectable satellite vehicles based on an estimated position and a time.

Clause 72. A non-transitory processor-readable storage medium comprising processor-readable instructions configured to cause one or more processors to enable a mobile device to switch between communication networks, comprising: code for receiving one or more signals via a terrestrial wireless communication network with the mobile device; code for detecting one or more signals from at least one satellite associated with a global navigation satellite system; code for determining a satellite communication network is available based at least in part on detecting the one or more signals from the at least one satellite associated with the global navigation satellite system: and code for detaching the mobile device from the terrestrial wireless communication network and activating a satellite communication mode on the mobile device.

1. A method for switching between communication networks, comprising:
receiving one or more signals via a first wireless communication network with a mobile device;
determining a second wireless communication network is available based at least in part on a location of the mobile device and a time;
detaching the mobile device from the first wireless communication network at the time if the second wireless communication network is available; and
receiving one or more signals from the second wireless communication network with the mobile device after the time.

2. The method of claim 1 wherein determining the second wireless communication network is available includes determining a context for the mobile device.

3. The method of claim 1 wherein the first wireless communication network is a cellular network and the second wireless communication network is a satellite network.

4. The method of claim 1 wherein the first wireless communication network is a first satellite network and the second wireless communication network is a second satellite network.

5. The method of claim 4 further comprising receiving one or more signals from a cellular network concurrently with receiving one or more signals on the first wireless communication network, and receiving one or more signals from the cellular network concurrently with receiving one or more signals on the second wireless communication network.

6. The method of claim 1 wherein determining the second wireless communication network is available includes determining that the location of the mobile device at the time is within a coverage area of second wireless communication network.

7. The method of claim 1 further comprising receiving a satellite observation forecast, wherein determining the second wireless communication network is available is based on an indication of one or more detectable satellite vehicles at the location and the time.

8. The method of claim 7 wherein the satellite observation forecast is received from a network station.

9. The method of claim 7 wherein the satellite observation forecast is received from a proximate user equipment via a sidelink.

10. The method of claim 1 further comprising providing satellite observation information to a network server, wherein the satellite observation information is based on signals received from the first wireless communication network, the second wireless communication network, or both.

11. A method of communicating on a wireless network, comprising:
determining a context for a user equipment;
detecting one or more applications executing on the user equipment;
determining one or more wireless communication networks based at least in part on the context and the one or more applications;
detecting at least one of the one or more wireless communication networks; and
connecting to the at least one of the one or more wireless communication networks based at least in part on priority values associated with the context and the one or more applications.

12. The method of claim 11 wherein determining the context for the user equipment is based on determining the user equipment is located within a structure.

13. The method of claim 11 wherein the one or more wireless communication networks include a cellular network and a satellite communication network.

14. The method of claim 11 wherein the one or more wireless communication networks include a first satellite communication network and a second satellite communication network.

15. The method of claim 11 wherein the one or more wireless communication networks include a Wi-Fi network and a satellite communication network.

16. The method of claim 11 wherein the one or more wireless communication networks include a sidelink based network and a satellite communication network.

17. The method of claim 11 wherein the one or more applications executing on the user equipment include at least one of a voice communication application, a messaging application, an email application, a media streaming application, a video calling application, a meeting application, or a navigation application.

18. The method of claim 11 further comprising connecting to a first wireless network and a second wireless network, wherein a first of the one or more applications is configured to utilize the first wireless network and a second of the one or more applications is configured to utilize the second wireless network.

19. The method of claim 18 wherein the first wireless network is a cellular network and the second wireless network is a satellite communication network.

20. The method of claim 18 wherein the first wireless network is a sidelink based network and the second wireless network is a satellite communication network.

21. The method of claim 18 wherein the first wireless network is a first satellite communication network and the second wireless network is a second satellite communication network.

22. A method of providing satellite coverage forecasts, comprising:
receiving satellite observation information from a plurality of mobile devices including an observation time and an observation location for each of a plurality of satellite observations performed by the plurality of mobile devices;
determining satellite location information based at least in part on the satellite observation information;
generating an observation forecast based at least in part on the satellite observation information and the satellite location information; and
providing the observation forecast to one or more mobile devices, wherein the observation forecast includes an indication of one or more detectable satellite vehicles based on an estimated position and a time.

23. The method of claim 22 wherein the satellite observation information includes observations of signals transmitted by one or more satellite vehicles in a global navigation satellite system.

24. The method of claim 22 wherein the satellite observation information includes observations of signals transmitted by one or more satellite vehicles in a satellite communication network.

25. The method of claim 22 wherein generating the observation forecast includes utilizing one or more machine learning methods with the satellite location information as training data and the satellite observation information as labels.

26. The method of claim 22 wherein providing the observation forecast includes transmitting the observation forecast in assistance data via a cellular communication messaging protocol.

27. The method of claim 22 wherein providing the observation forecast includes transmitting the observation forecast in assistance data via a sidelink communication messaging protocol.

28. A method for switching between communication networks, comprising:
receiving one or more signals via a terrestrial wireless communication network with a mobile device;
detecting one or more signals from at least one satellite associated with a global navigation satellite system;
determining a satellite communication network is available based at least in part on detecting the one or more signals from the at least one satellite associated with the global navigation satellite system; and
detaching the mobile device from the terrestrial wireless communication network and activating a satellite communication mode on the mobile device.

29. The method of claim 28 wherein detecting the one or more signals from the at least one satellite includes detecting a satellite identification code.

30. The method of claim 28 further comprising determining a location of the mobile device and transmitting an indication of the one or more signals and the location to a network server.
